(19) United States
(12) Patent Application Publication
(10) Pub. No.: US 2026/0216860 A1
(43) Pub. Date: Jul. 30, 2026

(54) A GRIPPING TOOL

(71) Applicant: Jason Jincheng Lin, Roselands (AU)

(72) Inventor: Jason Jincheng Lin, Roselands (AU)

(21) Appl. No.: 19/140,261

(22) PCT Filed: Dec. 22, 2023
(86) PCT No.: PCT/AU2023/051363

§ 371 Date: Jun. 17, 2025

(30) Foreign Application Priority Data
Dec. 23, 2022 (AU) 2022903993
Feb. 28, 2023 (AU) 2023900517
Sep. 22, 2023 (AU) 2023903069

(51) Int. Cl. B25J 1/04; E01H 1/12

(52) U.S. Cl. CPC B25J 1/04; E01H 1/12

(57) ABSTRACT

A gripping tool including: an elongate body having a first end, a second end, a longitudinal body axis, and a handle located at the second end of the elongate body, wherein the handle has a longitudinal handle axis which is substantially coaxial with at least a portion of the longitudinal body axis; a gripping mechanism located at the first end of the elongate body; a ratchet mechanism configured to restrict the gripping mechanism moving from a closed position to an open position, wherein the ratchet mechanism includes a pawl member configured to cooperate with a ratchet member, wherein the ratchet member is movable relative to the elongate body along the longitudinal body axis; a trigger mechanism operably coupled to the gripping mechanism, including: a trigger pivotally coupled to the elongate body and operably coupled to the ratchet member; and a force transfer medium operably coupled between the ratchet member and the gripping mechanism; wherein actuation of the trigger causes the ratchet member to move causing the force transfer medium to actuate the gripping mechanism to move from an open position to a closed position.

### RELATED APPLICATIONS

The present application claims the benefit of PCT application No. PCT/AU 2023/051363 filed on Dec. 22, 2023, which claims priority to Australian Patent Application No. 2022903993, filed 23 Dec. 2022, Australian Patent Application No. 2023900517, filed 28 Feb. 2023, and Australian Patent Application No. 2023903069, filed 22 Sep. 2023. The contents of the above applications are herein incorporated by reference in their entirety.

### TECHNICAL FIELD

The present invention relates to a hand actuated tool.

### BACKGROUND

Hand actuated tools such as various types of gripping tools are known. Gripping tools generally include a hand actuated trigger to move a claw from an open position to a closed position. However, these existing tools suffer from problems. Generally, the user is required to continue to actuate the trigger to maintain the claw in the closed position which can be awkward for the user. Additionally, the dexterity of the gripping action of the gripping tool cannot be adjusted. For example, whilst a gripping tool can be used to grip a jar from a high shelf, the same gripping tool will be difficult to operate to also pick up a coin from the ground. The level of dexterity to achieve these two different types of gripping tasks is variable which is not provided by existing gripping tools.

Additionally, once an object has been gripped, it can be difficult to manoeuvre the gripped object into the user's free hand. As shown in FIG. 70A, gripping tools which use a pistol-type handle relative to the elongate body of the gripping tool require cocking of the user's wrist which reduce the distance between an operating hand of the user which is holding the handle of the tool and a free hand to place the gripped object into. This is particularly a problem for smaller people who may already have a reduced span between their hands.

### SUMMARY

The present invention seeks to ameliorate one or more of the above-mentioned problems or provide a useful alternative.

In one aspect there is provided a gripping tool including: an elongate body having a first end, a second end, a longitudinal body axis, and a handle located at the second end of the elongate body, wherein the handle has a longitudinal handle axis which is substantially coaxial with at least a portion of the longitudinal body axis; a gripping mechanism located at the first end of the elongate body; a ratchet mechanism configured to restrict the gripping mechanism moving from a closed position to an open position, wherein the ratchet mechanism includes a pawl member configured to cooperate with a ratchet member, wherein the ratchet member is movable relative to the elongate body along the longitudinal body axis; a trigger mechanism operably coupled to the gripping mechanism, including: a trigger pivotally coupled to the elongate body and operably coupled to the ratchet member; and a force transfer medium operably coupled between the ratchet member and the gripping mechanism; wherein actuation of the trigger causes the ratchet member to move causing the force transfer medium to actuate the gripping mechanism to move from an open position to a closed position.

In one or more embodiments, the ratchet mechanism includes a pawl biasing device configured to bias the pawl member into cooperation with the ratchet member.

In one or more embodiments, the ratchet member is linearly movable relative to the elongate body.

In one or more embodiments, the gripping tool further includes a button operably coupled to the pawl member, wherein button is movable between an engaged position, wherein the pawl member is engaged with the ratchet member such that the gripping mechanism is restricted from moving from the closed position to the open position, and a disengaged position, wherein the pawl member is disengaged from the ratchet member such that the gripping mechanism is free to move from the closed position to the open position.

In one or more embodiments, the button is slidably actuatable in a direction parallel to the longitudinal body axis.

In one or more embodiments, the pawl member is rotatably coupled to the button via an axle.

In one or more embodiments, the handle includes a disengagement structure, wherein slidable movement of the button from the engaged position to the disengaged position causes the pawl member to disengage from the ratchet member and be supported upon the disengagement structure.

In one or more embodiments, slidable movement of the button from the disengaged position to the engaged position causes the pawl member to separate from the disengagement structure and cooperate with the ratchet member.

In one or more embodiments, the handle includes a hole to allow user actuation of the pawl member via the hole to disengage the pawl member from the ratchet member, wherein the handle includes a disengagement structure, wherein user actuation of the pawl member via the hole in the button and slidable movement of the button from the engaged position to the disengaged position causes the pawl member to disengage from the ratchet member and be supported upon the disengagement structure.

In one or more embodiments, user actuation of the pawl member via the hole in the button and slidable movement of the button from the disengaged position to the engaged position causes the pawl member to separate from the disengagement structure and cooperate with the ratchet member.

In one or more embodiments, the gripping tool further includes a frame insert to snap-fittingly engage with a hole in a wall of the handle, wherein the button is removably attachable to the frame insert for cooperation with the pawl member.

In one or more embodiments, the handle includes a disengagement structure, wherein the pawl member is configured to slidably move in a first direction along an axle and orthogonal relative to the longitudinal handle axis to a disengaged position to disengage the pawl member from the ratchet member and be supported by the disengagement structure.

In one or more embodiments, the pawl member is configured to slidably move in a second direction, opposite to the first direction and along the axle, to an engaged position, wherein the pawl member is configured to separate from the disengagement structure and engage with the ratchet member.

In one or more embodiments, the disengagement structure is configured to support the pawl member under bias from the pawl biasing device.

In one or more embodiments, the pawl biasing device includes one or more springs.

In one or more embodiments, the force transfer medium is coupled to a biasing device to bias the gripping mechanism from the closed position to the open position.

In one or more embodiments, the gripping mechanism includes a pair of levers which are operably connected to a slidable member, wherein slidable movement of the slidable member in response to actuation of the trigger actuates the pair of levers thereby moving the gripping mechanism toward the closed position.

In one or more embodiments, the gripping mechanism includes a first plurality of fingers pivotally connected to a second plurality of fingers, wherein the first and second plurality of fingers interleave when moved toward the closed position.

In one or more embodiments, the gripping mechanism includes a plurality of gripping covers releasably attached to the gripping ends.

In one or more embodiments, the plurality of gripping covers are releasably attachable to the gripping tool in a stowed position remote to the gripping ends, wherein the covers are releasably detachable from the stowed position and releasably attachable to the gripping ends in an operable position.

In one or more embodiments, each gripping cover is further coupled to the gripping tool via one or more tethers.

In one or more embodiments, the tethers are elastic tethers.

In one or more embodiments, the elongate body includes a plurality of body portions pivotally connected together via one or more hinge assemblies, wherein each hinge assembly has one or more locked positions to maintain an angular displacement between connected body portions, and one or more unlocked positions.

In one or more embodiments, the gripping tool is movable between a stowed position, wherein the plurality of body portions are foldable upon each other via the plurality of hinge assemblies, and a deployed position, wherein the plurality of body portions are aligned along a longitudinal axis of the elongate body.

In one or more embodiments, substantial coaxiality between the longitudinal axis and the longitudinal body axis includes an angle of deflection between one of: 0 to 20 degrees; 0 to 15 degrees; 0 to 10 degrees; and 0 to 5 degrees.

In one or more embodiments, one or more linkage members are operably coupled between the trigger and the ratchet member.

In one or more embodiments, the handle includes a releasable coupling mechanism for releasably coupling the gripping tool to an object.

In one aspect there is provided a gripping tool including: an elongate body having a first end, a second end, wherein a handle is located at the second end of the elongate body; a gripping mechanism located at the first end of the elongate body, the gripping mechanism including gripping ends; a trigger mechanism operably coupled to the gripping mechanism to cause the gripping mechanism to move between an open position and a closed position in response to actuation of a trigger of the trigger mechanism; and a plurality of gripping covers movable between an operable position, wherein each gripping cover is releasably attachable to one of the gripping ends of the gripping mechanism, and a stowed position, wherein each gripping cover is releasably attached to the gripping tool whilst being stowed remote to the gripping ends, wherein each gripping cover is coupled to the gripping tool via one or more tethers.

In one or more embodiments, each tether is an elastic tether.

In one or more embodiments, in the stowed position, the plurality of covers are snap-fittingly attached.

In one or more embodiments, each cover includes one or more male snap fitting joints which snap-fittingly attach to a respective one or more female snap fitting joints located on a portion of the gripping mechanism.

In one or more embodiments, each cover includes one or more female snap fitting joints which snap-fittingly attach to a respective one or more male snap fitting joints located on a portion of the gripping mechanism.

In one or more embodiments, the elongate body has a longitudinal body axis, and the handle has a longitudinal handle axis which is substantially coaxial with at least a portion of the longitudinal body axis.

In one or more embodiments, the gripping tool further includes a force transfer medium operably coupled between the trigger mechanism and the gripping mechanism, wherein actuation of the trigger causes the force transfer medium to actuate the gripping mechanism to move from the open position to the closed position.

In one or more embodiments, the gripping tool further includes a ratchet mechanism configured to restrict the gripping mechanism moving from the closed position to the open position, wherein the ratchet mechanism includes a pawl member configured to cooperate with a ratchet member, wherein the ratchet member is movable relative to the elongate body along the longitudinal body axis, wherein the ratchet member is operably coupled to the trigger and the force transfer medium.

In one or more embodiments, one or more linkage members are operably coupled between the trigger and the ratchet member.

In one or more embodiments, the ratchet mechanism includes a pawl biasing device configured to bias the pawl member into cooperation with the ratchet member.

In one or more embodiments, the gripping tool further includes a button operably coupled to the pawl member, wherein button is movable between an engaged position, wherein the pawl member is engaged with the ratchet member such that the gripping mechanism is restricted from moving from the closed position to the open position, and a disengaged position, wherein the pawl member is disengaged from the ratchet member such that the gripping mechanism is free to move from the closed position to the open position.

In one or more embodiments, the button is slidably actuatable in a direction parallel to the longitudinal body axis.

In one or more embodiments, the pawl member is rotatably coupled to the button via an axle.

In one or more embodiments, the handle includes a disengagement structure, wherein slidable movement of the button from the engaged position to the disengaged position causes the pawl member to disengage from the ratchet member and be supported upon the disengagement structure.

In one or more embodiments, slidable movement of the button from the disengaged position to the engaged position causes the pawl member to separate from the disengagement structure and cooperate with the ratchet member.

In one or more embodiments, the handle includes a hole to allow user actuation of the pawl member via the hole to disengage the pawl member from the ratchet member, wherein the handle includes a disengagement structure, wherein user actuation of the pawl member via the hole in the button and slidable movement of the button from the engaged position to the disengaged position causes the pawl member to disengage from the ratchet member and be supported upon the disengagement structure.

In one or more embodiments, user actuation of the pawl member via the hole in the button and slidable movement of the button from the disengaged position to the engaged position causes the pawl member to separate from the disengagement structure and cooperate with the ratchet member.

In one or more embodiments, the gripping tool further includes a frame insert to snap-fittingly engage with a hole in a wall of the handle, wherein the button is removably attachable to the frame insert for cooperation with the pawl member.

In one or more embodiments, the handle includes a disengagement structure, wherein the pawl member is configured to slidably move in a first direction along an axle and orthogonal relative to the longitudinal handle axis to a disengaged position to disengage the pawl member from the ratchet member and be supported by the disengagement structure.

In one or more embodiments, the pawl member is configured to slidably move in a second direction, opposite to the first direction and along the axle, to an engaged position, wherein the pawl member is configured to separate from the disengagement structure and engage with the ratchet member.

In one or more embodiments, the disengagement structure is configured to support the pawl member under bias from the pawl biasing device.

In one or more embodiments, the pawl biasing device includes one or more springs.

In one or more embodiments, the force transfer medium is coupled to a biasing device to bias the gripping mechanism from the closed position to the open position.

In one or more embodiments, the gripping mechanism includes a pair of levers which are operably connected to a slidable member, wherein slidable movement of the slidable member actuates the pair of levers thereby moving the gripping mechanism toward the closed position.

In one or more embodiments, the gripping mechanism includes a first plurality of fingers pivotally connected to a second plurality of fingers, wherein the first and second plurality of fingers interleave when moved toward the closed position and the covers being in the stowed position.

In one or more embodiments, the gripping mechanism includes a first gripping arm pivotally connected to a second gripping arm, wherein gripping surfaces of the first and second gripping arms include an anti-slip material.

In one or more embodiments, the gripping mechanism includes a first gripping arm pivotally connected to a second gripping arm, wherein a pivotal connection between the first and second gripping arms are at least partially housed by a frame, wherein a portion of the frame includes an anti-slip material.

In one or more embodiments, the elongate body includes a plurality of body portions pivotally connected together via one or more hinge assemblies, wherein each hinge assembly has one or more locked positions to maintain an angular displacement between connected body portions, and one or more unlocked positions.

In one or more embodiments, the gripping tool is movable between a stowed position, wherein the plurality of body portions are foldable upon each other via the plurality of hinge assemblies, and a deployed position, wherein the plurality of body portions are aligned along a longitudinal axis of the elongate body.

In one or more embodiments, the gripping tool includes a wireless controller to control an electronic device gripped by the gripping tool.

In one or more embodiments, the handle includes a releasable coupling mechanism for releasably coupling the gripping tool to an object.

Other aspects and embodiments will be appreciated throughout the detailed description.

### BRIEF DESCRIPTION OF THE FIGURES

The invention is described, by way of non-limiting example only, by reference to the accompanying figures.

FIG. 1 is an isometric view of an example of a gripping tool.

FIG. 2 is an isometric view of the gripping tool of FIG. 1 in a stowed position.

FIG. 3 is an isometric view of the gripping tool of FIG. 1 with the gripping mechanism rotated about a longitudinal axis relative to FIG. 1.

FIG. 4 is an isometric view of an example of an apparatus including the gripping tool of FIG. 1 releasably attached to a stand in a stowed position.

FIG. 5 is an isometric view of an apparatus of FIG. 4 showing the gripping tool separated from the stand.

FIG. 6 is an isometric view of the apparatus of FIG. 5 with the stand moved to a deployed position.

FIG. 7 is an isometric view of the apparatus of FIG. 5 with the gripping mechanism rotated at a hinge mechanism.

FIG. 8 is an isometric cross-sectional view of the gripping mechanism of the gripping tool of FIG. 1.

FIG. 9 is a front cross-sectional view of the gripping mechanism of the gripping tool of FIG. 1 in a closed position with gripping arms interleaved.

FIG. 10 is a bottom isometric view of the gripping mechanism of the gripping tool of FIG. 1 in a closed position with finger covers attached to gripping ends of the gripping mechanism.

FIG. 11A an isometric cross-sectional view of the gripping mechanism of the gripping tool in an open position.

FIG. 11B is an isometric cross-sectional view of the gripping mechanism of the gripping tool in an open position with the gripping mechanism partially separated from the body portions of the gripping tool.

FIG. 12A is a further isometric cross-sectional view of the gripping mechanism of the gripping tool of FIG. 1 in the open position with the gripping mechanism partially separated from the body portions of the gripping tool.

FIG. 12B is a further isometric cross-sectional view of the gripping mechanism of the gripping tool in an open position.

FIG. 13 is an end view of the gripping mechanism of the gripping tool of FIG. 1.

FIG. 14 is an isometric view of the handle of the gripping tool of FIG. 1 in the open position.

FIG. 15 is a cross-sectional right-side view of the handle of the gripping tool of FIG. 1 in the open and engaged position.

FIG. 16 is a cross-sectional right-side view of the handle of the gripping tool of FIG. 1 in the closed and engaged position.

FIG. 17 is a cross-sectional right-side view of the handle of the gripping tool of FIG. 1 in the closed and disengaged position.

FIG. 18A is a cross-sectional right-side view of the handle of the gripping tool of FIG. 1 in an open and intermediary position.

FIG. 18B is a cross-sectional right-side view of the handle of the gripping tool of FIG. 1 in an open and disengaged position.

FIG. 19 is an exploded isometric view of the handle of the gripping tool of FIG. 1.

FIG. 20 is an isometric view of a hinge assembly of the gripping tool of FIG. 1 in a locked position.

FIG. 21 is a cross-sectional isometric view of the hinge assembly of the gripping tool of FIG. 1 in a locked position.

FIG. 22 is a cross-sectional isometric view of the hinge assembly of the gripping tool of FIG. 1 in an unlocked position.

FIG. 23 is a cross-sectional isometric view of the hinge assembly of the gripping tool of FIG. 1 hingedly moved from the unlocked position of FIG. 22 to a further unlocked position.

FIG. 24 is a cross-sectional isometric view of the hinge assembly of the gripping tool of FIG. 1 hingedly moved from the further unlocked position of FIG. 23 to a further locked position.

FIG. 25 is an exploded isometric view of the hinge assembly of the gripping tool of FIG. 1.

FIG. 26 is an exploded top view of the hinge assembly of the gripping tool of FIG. 1.

FIG. 27 is a top and right-side isometric view of the stand of the apparatus of FIG. 4 in a stowed position.

FIG. 28 is an underside isometric view of the stand of the apparatus of FIG. 4 in the stowed position.

FIG. 29 is a cross-sectional view of the stand of the apparatus of FIG. 4 in the stowed position.

FIG. 30A is an underside isometric view of the stand of the apparatus of FIG. 4 in a deployed position.

FIG. 30B is a magnified isometric view of portion A of the stand of FIG. 30A.

FIG. 31A is a top isometric view of the stand of the apparatus of FIG. 4 in a deployed and unlocked position.

FIG. 31B is a magnified isometric view of portion B of the stand of FIG. 31A.

FIG. 32A is a top isometric view of the stand of the apparatus of FIG. 4 in a deployed and locked position.

FIG. 32B is a magnified isometric view of portion C of the stand of FIG. 32A.

FIG. 33A is a cross-sectional view of the lower portion of the apparatus of FIG. 4 showing the handle of the gripping tool releasably connected to the stand.

FIG. 33B is a magnified isometric view of portion D of the stand of FIG. 33A.

FIG. 34 is an exploded isometric underside view of the stand of the apparatus of FIG. 4.

FIG. 35 is an exploded isometric top view of an example of the apparatus of FIG. 4.

FIG. 36 is magnified isometric view of an alternate ratchet mechanism for the gripping tool of FIG. 1.

FIG. 37 is a magnified cross-sectional isometric view of the gripping tool of FIG. 36 with the ratchet mechanism in the engaged position and the trigger has not been actuated.

FIG. 38 is a magnified cross-sectional isometric view of the ratchet mechanism of the gripping tool of FIG. 36 in the engaged position, wherein the trigger has been actuated.

FIG. 39 is a magnified cross-sectional isometric view of the ratchet mechanism of the gripping tool of FIG. 36 in the disengaged position and wherein the trigger has been actuated.

FIG. 40 is a magnified cross-sectional isometric view of the ratchet mechanism of the gripping tool of FIG. 36 in the disengaged position wherein the trigger has not been actuated.

FIG. 41 is a magnified isometric view of a releasably attachable button assembly for releasable attachment to the handle of the gripping tool of FIG. 36.

FIG. 42 is a schematic view of an apparatus including the gripping tool of FIG. 1 including the handle and trigger mechanism of FIG. 36 releasably coupled to an alternate example of a stand in a first stowed position.

FIG. 43 is a schematic view of the apparatus of FIG. 42 including the stand configured in a deployed position.

FIG. 44 is a schematic view of the apparatus of FIG. 42 including the stand configured in a second stowed position.

FIG. 45 is a schematic view of the apparatus of FIG. 42 including the gripping tool being configured in the stowed position and the stand being configured in the second stowed position.

FIG. 46 is a magnified cross-sectional view of the apparatus showing a coupling mechanism of the stand which is releasably coupled to the handle of the gripping tool.

FIG. 47 is a magnified cross-sectional view of the apparatus showing separation between the coupling mechanism of the stand and the handle of the gripping tool.

FIG. 48 is magnified side view of the apparatus showing the coupling mechanism of the stand which is releasably coupled to the handle of the gripping tool.

FIG. 49 is a magnified side view of a hinge assembly connecting a base and legs of the stand whilst the stand is configured in the second stowed position.

FIG. 50 is a magnified side view of the apparatus showing a hinge assembly of the stand hingedly connecting a base and legs of the stand whilst the stand is configured in the deployed position.

FIG. 51 is a partial and isolated cross-sectional view of the apparatus showing the coupling mechanism of the stand releasably coupled to the handle of the gripping tool.

FIG. 52 is a magnified partial and isolated cross-sectional view of the coupling mechanism of FIG. 51 which releasably couples the stand to the handle.

FIG. 53 is an exploded schematic view of the stand for releasable coupling to the gripping tool of FIG. 36.

FIG. 54 is schematic view of an alternate example of a gripping tool including an alternate gripping mechanism.

FIG. 55 is a schematic view of a further alternate example of a gripping tool including a further alternate gripping mechanism.

FIG. 56 is a schematic view of a further alternate example of a gripping tool including a further alternate gripping mechanism.

FIG. 57 is a cross-sectional view of an alternate hinge assembly of the gripping tool of FIG. 1.

FIG. 58 is a cross-sectional view of the hinge assembly of FIG. 57.

FIG. 59 is a further cross-sectional view of the hinge assembly of FIG. 57.

FIG. 60A is a rear and top schematic view of an alternate example of a gripping mechanism of the gripping tool including covers stored in the stowed position.

FIG. 60B is a front and rear schematic view of the gripping mechanism of FIG. 60A.

FIG. 61A is a rear and top schematic view of the gripping mechanism of FIG. 60A with the gripping covers moved to the operable position.

FIG. 61B is a further rear and underside schematic view of the gripping mechanism of FIG. 60A with the gripping covers moved to the operable position.

FIG. 62A is a rear and top schematic view of the gripping mechanism of FIG. 60A with the gripping mechanism being moved to the closed position.

FIG. 62B is a top schematic view of the gripping mechanism of FIG. 60A with the gripping mechanism being moved to the closed position.

FIG. 63 is a schematic view of an alternate example of the gripping tool including a wireless controller.

FIG. 64 is partially exploded view of the second end of the elongate body of the gripping tool of FIG. 63.

FIG. 65A is an isometric cross-sectional view of an alternate ratchet mechanism of the gripping tool of FIG. 1, wherein the alternate locking mechanism is in the unlocked position.

FIG. 65B is an isometric cross-sectional view of the alternate ratchet mechanism of FIG. 65A in the engaged position.

FIG. 66A is an isometric cross-sectional view of an alternate ratchet mechanism of the gripping tool of FIG. 1, wherein the alternate ratchet mechanism is in the disengaged position.

FIG. 66B is a cross-sectional side view of the alternate ratchet mechanism of FIG. 66A in the engaged position.

FIG. 67A is an isometric cross-sectional view of another alternate ratchet mechanism of the gripping tool of FIG. 1, wherein the alternate ratchet mechanism is in the disengaged position.

FIG. 67B is a side cross-sectional view of the alternate ratchet mechanism of FIG. 67A in the engaged position.

FIG. 67C is an isometric cross-sectional view of the alternate ratchet mechanism of FIG. 67A in the disengaged position wherein the pawl is supported upon a disengagement structure.

FIG. 68A is a cross-sectional side view of an alternate ratchet mechanism in the disengaged position for the gripping tool of FIG. 1, wherein the pawl is supported upon a disengagement structure.

FIG. 68B is a cross-sectional side view of the alternate ratchet mechanism of FIG. 68A in the engaged position wherein the trigger has been actuated.

FIG. 69A is a cross-sectional isometric view of an alternate trigger mechanism for the gripping tool of FIG. 1.

FIG. 69B is a cross-sectional isometric view of an alternate trigger mechanism of FIG. 1 where the trigger has been actuated by a user to move the ratchet.

FIG. 70A is a prior art gripping tool being operated by a user to hold an object.

FIG. 70B is the gripping tool of FIG. 1 being operated by a user to hold an object.

FIG. 71 is a schematic view of an alternate example of a gripping tool.

### DETAILED DESCRIPTION

The following modes, given by way of example only, are described to provide a more precise understanding of the subject matter of a preferred embodiment or embodiments. In the figures, incorporated to illustrate features of an example embodiment, like reference numerals are used to identify like parts throughout the figures.

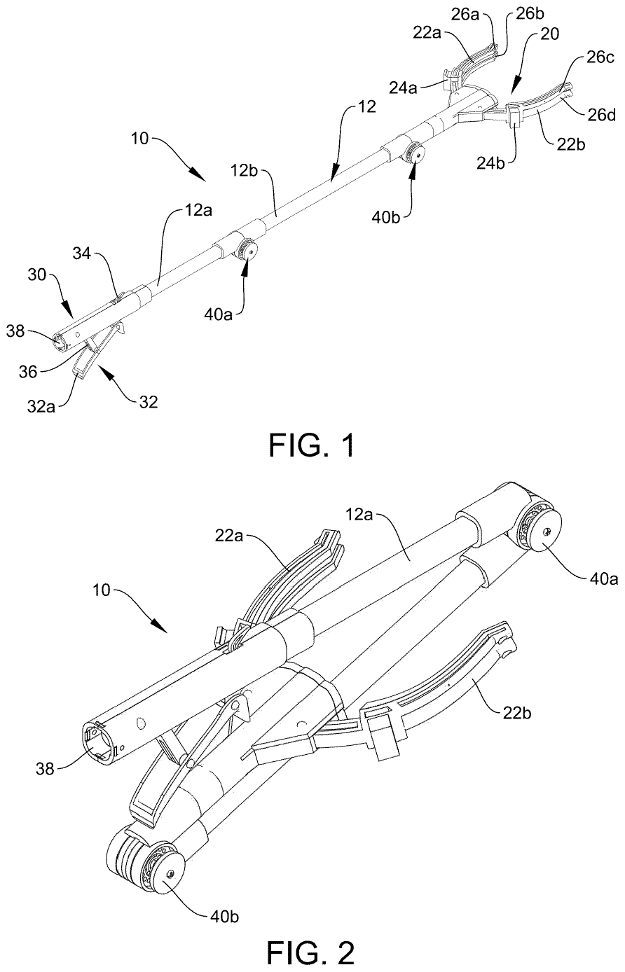

Referring to FIGS. 1 to 3 and FIG. 71 there is shown an example of a gripping tool 10. The gripping tool 10 includes an elongate body 12, a gripping mechanism 20, and a trigger mechanism 32.

In certain embodiments, the elongate body 12 has a first end and a second end. The gripping mechanism 20 is located at the first end of the elongate body 12. The elongate body includes a handle 30 is located at the second end of the elongate body 12. The trigger mechanism 32 operably coupled to the gripping mechanism 20 to cause the gripping mechanism 20 to move between an open position and a closed position in response to actuation of the trigger mechanism.

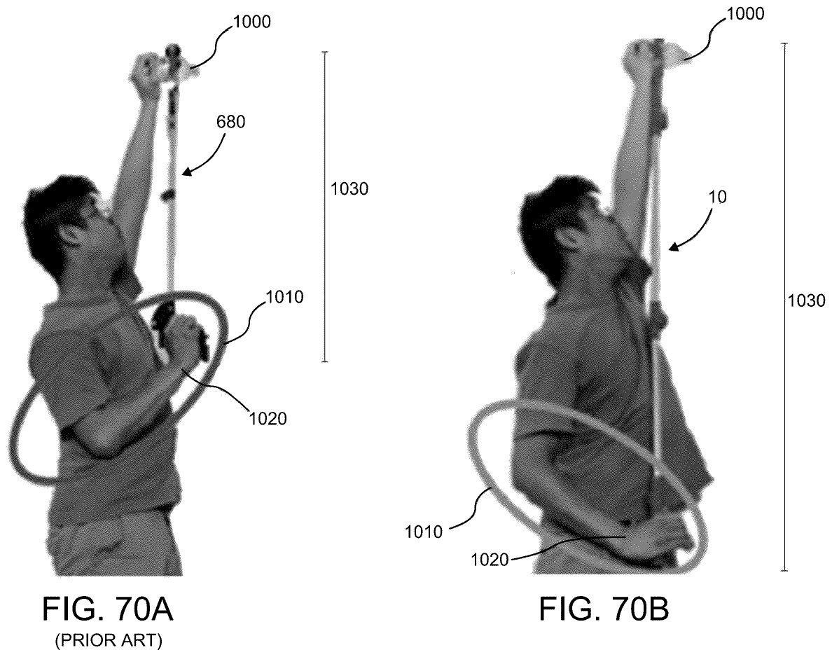

The elongate body has a longitudinal body axis, and a handle has a longitudinal handle axis. In certain embodiments, the longitudinal handle axis is coaxial with at least a portion of the longitudinal body axis. In one or more embodiments, substantial coaxiality between the longitudinal handle axis and the longitudinal body axis has an angle of deflection between 0 to 20 degrees. More specifically, the angle of deflection is between 0 to 15 degrees, and more specifically 0 to 10 degrees, and more specifically 0 to 5 degrees. It will be appreciated that the angle of deflection within this range still allows the gripping tool to be operated in an advantageous manner. More specifically, as shown in FIG. 70B, biomechanically, this configuration is advantageous as the distance between the user's operating hand 1020 and the free hand is greater than “pistol-grip” configuration of prior art gripping tools 680 as shown in FIG. 70A. This thereby allows a user to move the gripping ends of the gripping mechanism toward their free hand to release the gripped object 1000 in their free hand whilst holding the gripping tool using their operating hand 1020. More specifically, the user is able to angle their operating arm 1010 angularly downwardly whilst still being able to operate the gripping tool 10 using their operating hand 1020, meaning that the distance 1030 between the hands is greater using the gripping tool of FIG. 1 compared to prior art “pistol grip” arrangements as exemplified in FIG. 70A. This is a significant advantage for small people who may have a small wingspan between their hands.

In certain embodiments, the gripping tool 10 includes a plurality of gripping covers 24a, 24b. The plurality of gripping covers 24a, 24b can be releasably attached to gripping ends of the gripping mechanism 20 in an operable position. Advantageously, the gripping covers 24a, 24b provide flexibility in terms of the applicable gripping dexterity of the gripping tool 10. In certain instances where a clasping grip is required, the gripping covers 24a, 24b can be placed in a stowed position, and in instances where a fine gripping action is required, such as picking up a coin from a substrate surface, the gripping covers 24a, 24b can be placed in the operable position to provide appropriate fine dexterity due to the opposing gripping contact point surfaces.

The covers 24a, 24b can be located in the stowed position and attached to the gripping tool 10, remote to the gripping ends, whilst not located in an operable position. The covers 24a, 24b are able to be releasably detached from the stowed position and attached to gripping ends of the gripping mechanism in the operable position. However, it will be appreciated in other embodiments, the gripping covers 24a, 24b may simply be stowed separately to the gripping tool 10 and then can be attached to the gripping ends of the gripping mechanism 20 in the operable position.

In certain embodiments, the gripping tool 10 includes a ratchet mechanism 168, which restricts the gripping mechanism 20 moving from a closed (i.e., gripped) position to an open position. This feature is advantageous as the user is not required to continue to actuate a trigger 34A of the trigger mechanism 34 to maintain the gripping mechanism 20 in the closed position which can be awkward for the user. As will be explained throughout various examples, the user is able to selectively move the ratchet mechanism 168 between an engaged position and a disengaged position depending upon the required operation of the gripping tool 10.

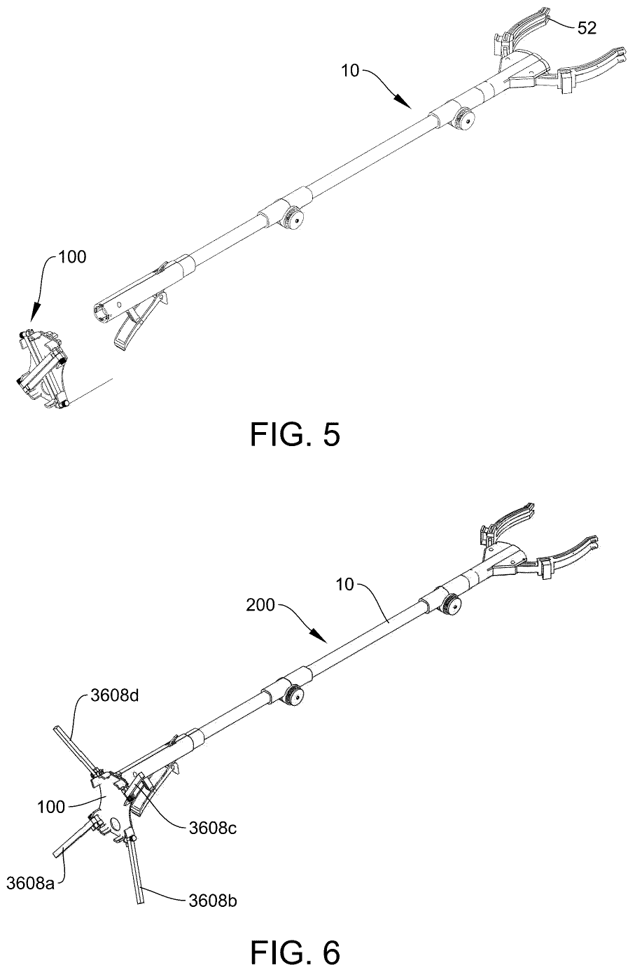

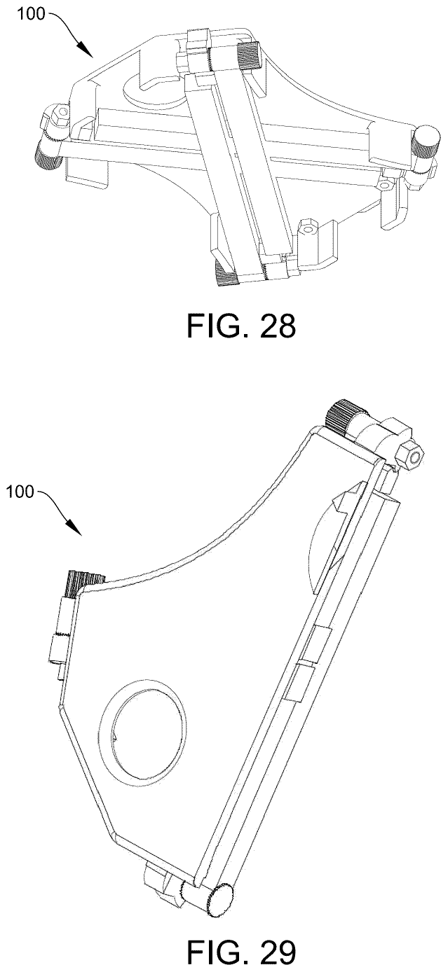

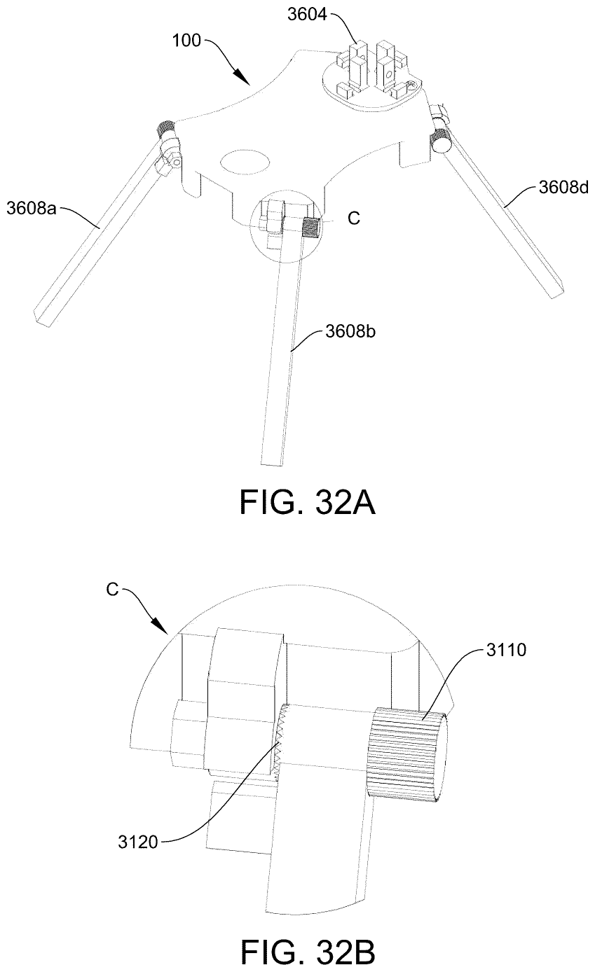

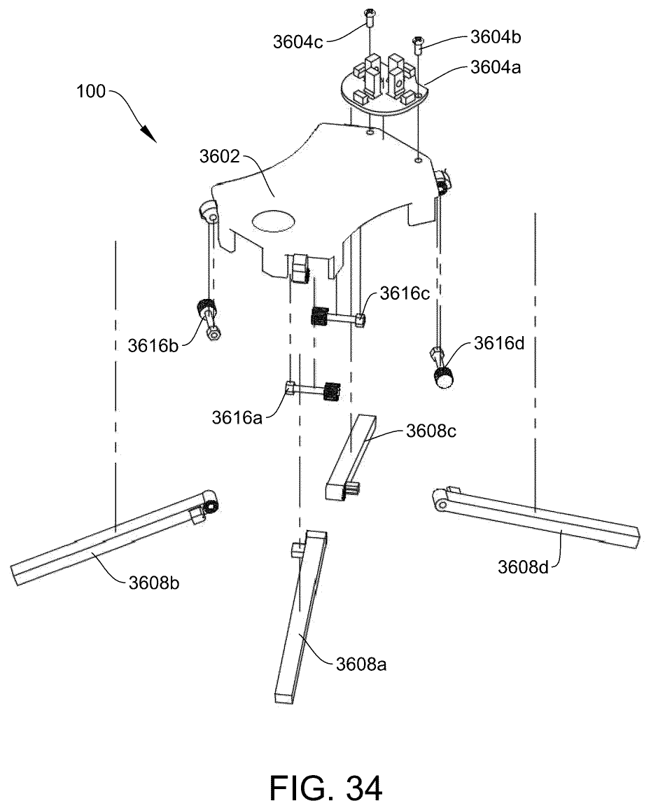

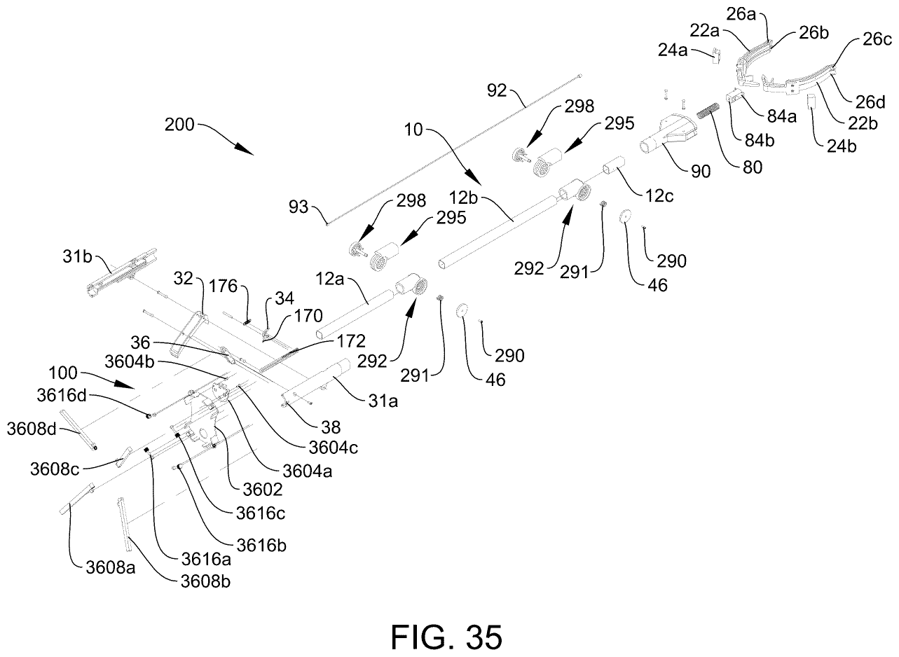

Referring to FIGS. 4 to 7, there is shown a gripping apparatus 200. The gripping apparatus 200 includes the gripping tool 10 as depicted in FIGS. 1 to 3 and 71, and a stand 100 which is also depicted in FIGS. 27 to 34. The handle 30 of the gripping tool 10 includes a releasable coupling mechanism 38 for releasably coupling the gripping tool 10 to the stand 100. The stand 100 is configured to be releasably coupled to the releasable coupling mechanism 38 of the gripping tool 10 to support the gripping tool 10.

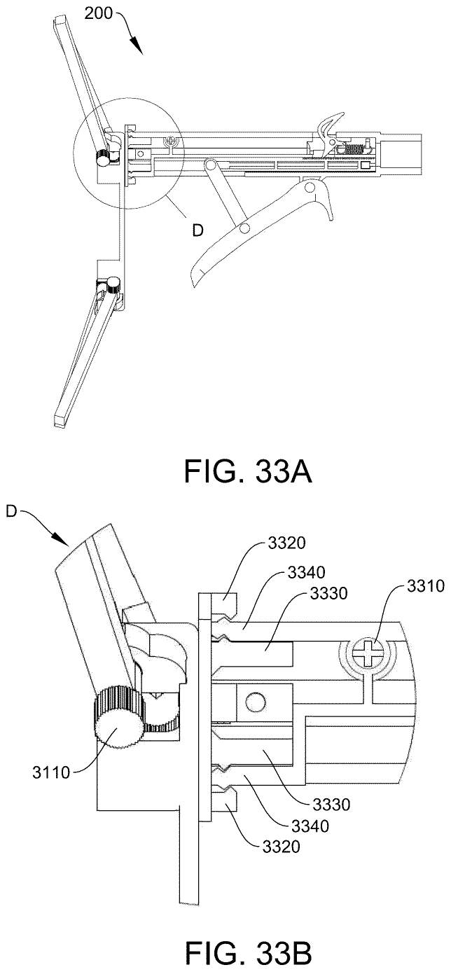

As shown in FIGS. 33A and 33B, upstanding inner and outer prongs of the releasable coupling mechanism 38 together define a gap therebetween for receiving a portion of a tubular wall of the end of the handle 30. The coupling mechanism 38 of the handle 30 and the stand include a plurality of complimentary protruding ridges and grooves which releasably and resiliently engage (e.g., snap fittingly engage) the portions of the apparatus together. As will be discussed in more detail below, the stand 100 has a plurality of legs 3608a-d which hingedly move between a stowed position as shown in FIG. 4, and a deployed position as shown in FIG. 6.

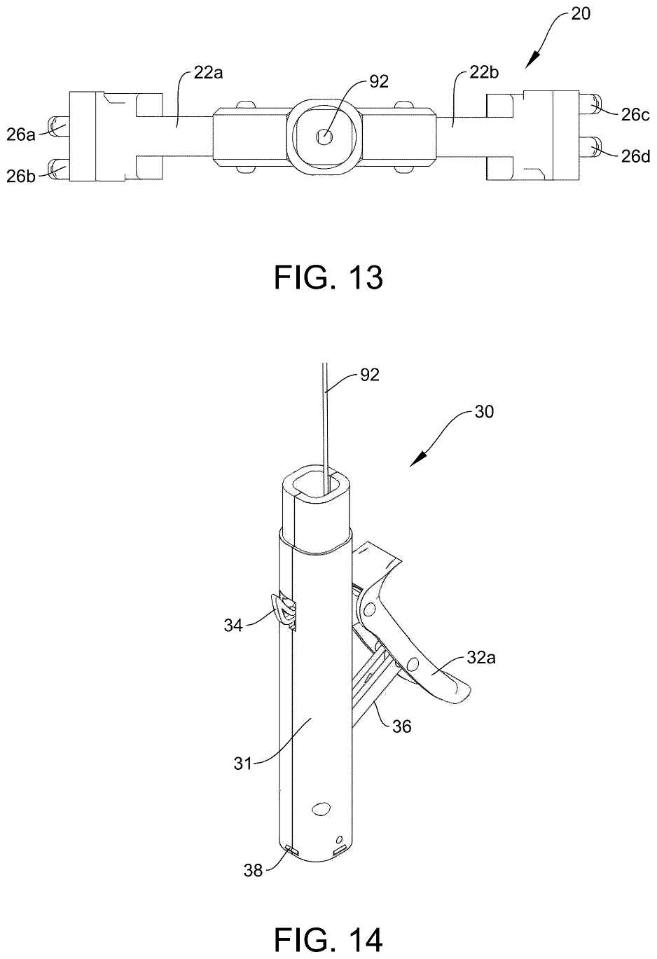

Referring to FIGS. 8 to 13, there is shown various views of the gripping mechanism 20 of the gripping tool of FIGS. 1 to 3 and FIG. 71. In particular, the gripping mechanism 20 includes a plurality of gripping arms 22a, 22b which hingedly move relative to each other in response to actuation of the trigger mechanism 32.

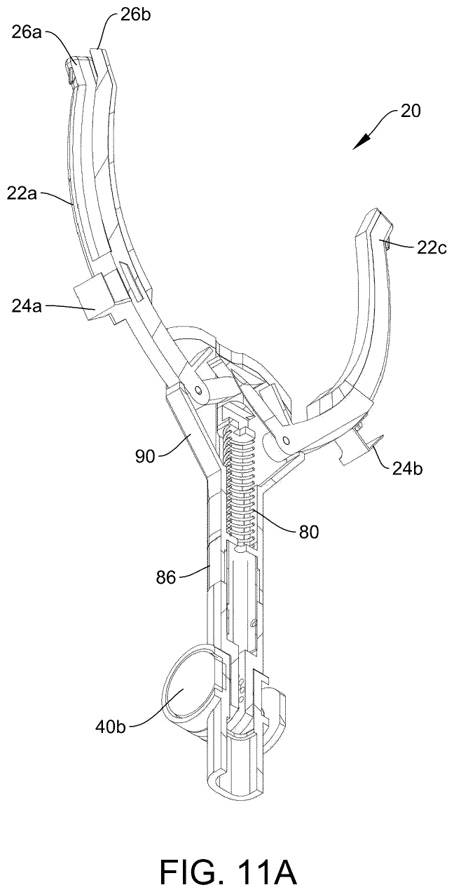

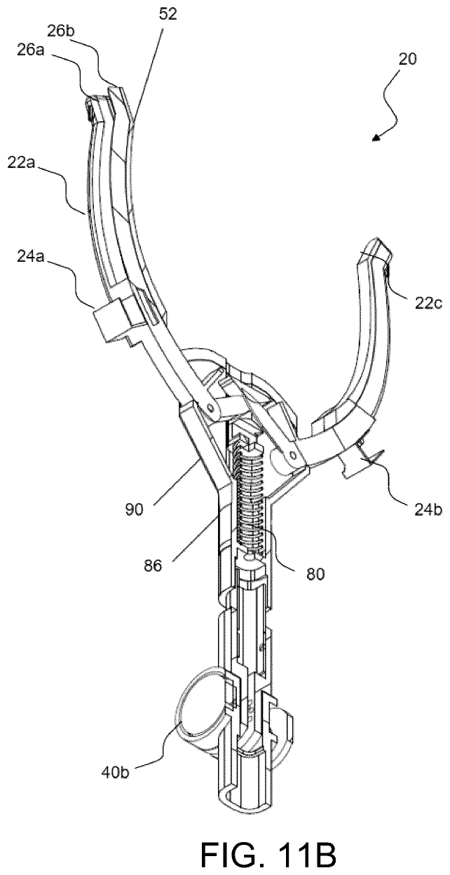

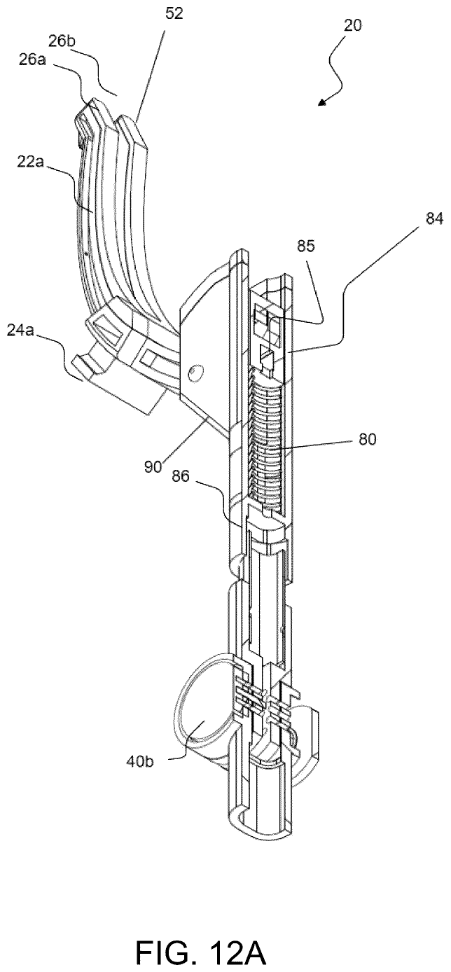

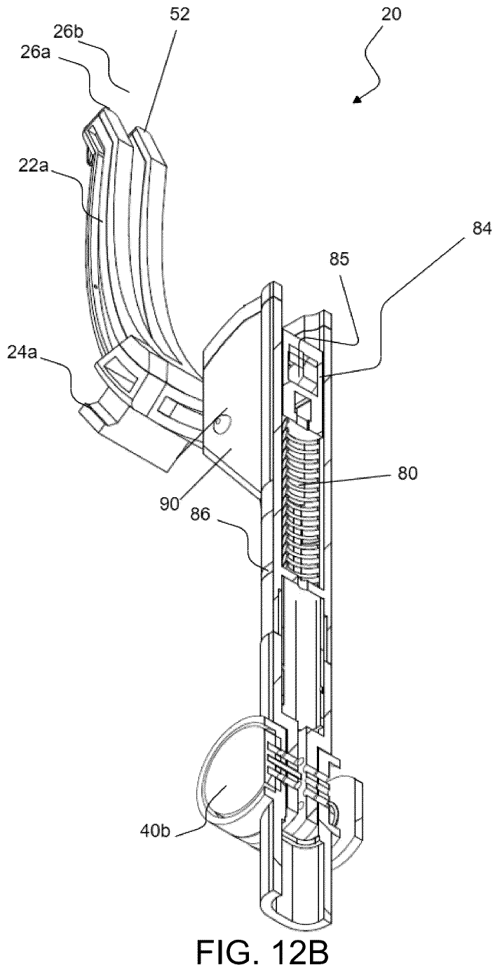

The gripping mechanism 20 includes a frame 90 which the plurality of gripping arms 22a, 22b are hingedly connected thereto. The frame 90 includes a neck 86 which couples to an end of a body portion 12c (see FIGS. 11B and 12A) forming the elongate body 12. The frame 90 defines a cavity housing a biasing component 80, provided in the form of a spring, such as a compression spring, as well as a slidable member 84. A first tail of the spring 80 is mounted within the neck 86 of the frame 90. A second tail of the spring 80 is coupled to the slidable member 84. A force transfer medium 92, such as a flexible force transfer medium including a cable, cord, rope or the like is connected between the trigger mechanism 32 and the slidable member 84.

In response to actuation of the trigger mechanism 32 (i.e., a user squeezing the trigger lever of the trigger mechanism 32), the force transfer medium 92 is pulled toward the trigger mechanism 32 which causes the slidable member 84 to slidably move in a direction coaxial with at least a portion of the longitudinal axis of the elongate body 12 within the cavity of the frame 90 toward the trigger mechanism 32. This results in the spring 80 being compressed by the slidable member 84 and the gripping arms 22a, 22b pivotally moving from the open position to the closed position. In particular, each gripping arm 22a, 22b includes a lever 82a, 82b located in a cavity 85 between a first and second portion 84a, 84b of the slidable member 84, wherein the levers 82a, 82b are actuated in response to the slidable movement of the slidable member thereby causing the gripping arms 22a, 22b to move toward the closed position. When the trigger mechanism 32 moves from an actuated position to an unactuated position, the spring 80 biases the slidable member 84 to slidably move within the cavity of the of the frame 90 toward the gripping ends of the gripping mechanism 20, resulting in the levers 82a, 82b being actuated and the gripping arms 22a, 22b pivotally moving relative to each other toward the open position.

Each arm 22a, 22b includes a gripping end and at an opposing end provided with a lever 82. The pair of levers 82a, 82b of the pair of arms 22a, 22b are located within the cavity 85 of the slidable member 84. In particular, slidable movement of the slidable member 84 within the cavity of the frame 90 pivotally actuates the pair of levers 82a, 82b thereby pivotally actuating the gripping arms 22a, 22b of the gripping mechanism 20 from an open position to a closed position.

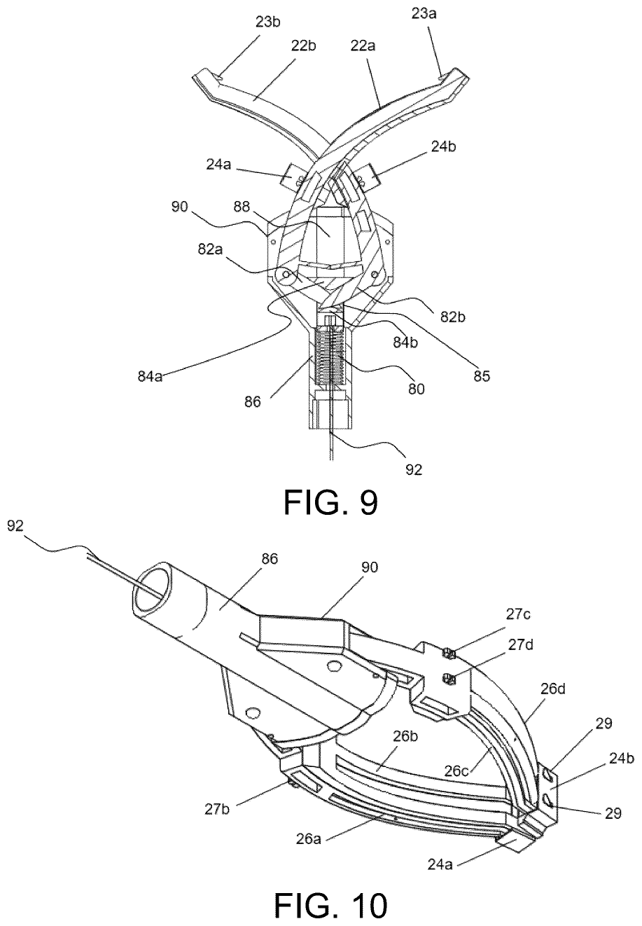

As shown in FIG. 10, each gripping arm 22a, 22b includes a plurality of fingers 26a-d. In particular, the gripping mechanism 20 includes a first plurality of fingers 26a, 26b which are able to pivotally move relative to a second plurality of fingers 26c, 26d. As shown in FIG. 9, the first and second plurality of fingers 26a-d interleave when moved toward the closed position. The fingers of the first and second plurality of fingers 26a-d are stacked upon each other with a gap located therebetween, thereby allowing one of the fingers of the opposing arm 22 to be move within the gap thereby allowing the interleaving action of the arms 22 so as the clasp around an object.

If an object to be gripped requires a higher level of gripping dexterity compared to a clasping action, the gripping tool 10 includes releasably attachable gripping covers 24a, 24b, as shown in FIG. 9, which are releasably attached to the gripping tool 10 in a stowed position remote to the opposing gripping ends of the gripping mechanism 20. As shown in FIG. 10, the covers 24a, 24b are able to be releasably detached from the stowed position and attached to the gripping ends to provide opposing gripping contact point surfaces. As such, the interleaving action of the arms 22 is inhibited by the gripping covers 24a, 24b, but a small opposing gripping contact surface is created by the covers which allow for greater gripping dexterity when attempting to grip small items.

The fingers of the arms can additionally include a gripping overlay 52 (see FIGS. 11B and 12A), such as a rubber overlay, to provide additional gripping effect for gripping objects having a smooth surface. The non-slip overlay 52, such as a rubber overlay, can be attached in the concave surface of each finger without webbing provided between the fingers to thereby allow for interleaving of the fingers to allow for a clasping action whilst also providing for additional grip.

As shown in FIG. 10, the outer surface (i.e., the surface which does not providing a gripping surface) of the arms 22 include clips which define the stowed position of the gripping covers 24a, 24b. The gripping covers 24a, 24b include a complementary protrusion 29 to releasably engage with the clips 27a-d to thereby hold the covers 24a, 24b in the stowed position. The gripping covers 24a, 24b can then be detached from the stowed position and placed over the gripping ends of each gripping arm 22a, 22b to thereby provide the opposing gripping contact point between the gripping ends of the gripping arms 22a, 22b. The gripping ends of the fingers 26a-d of the gripping arms 22a, 22b can be squeezed into a cavity of the gripping covers 24a, 24b in a tight-fitting arrangement such that each cover 24a, 24b is resiliently held on the respective gripping end. Once the gripping covers 24a, 24b are no longer required for gripping an object, the covers 24a, 24b can be pulled off the gripping ends and can be located in the stowed position via clipping engagement between the clips 25a, 25b and protrusions 29 of the covers 24a, 24b.

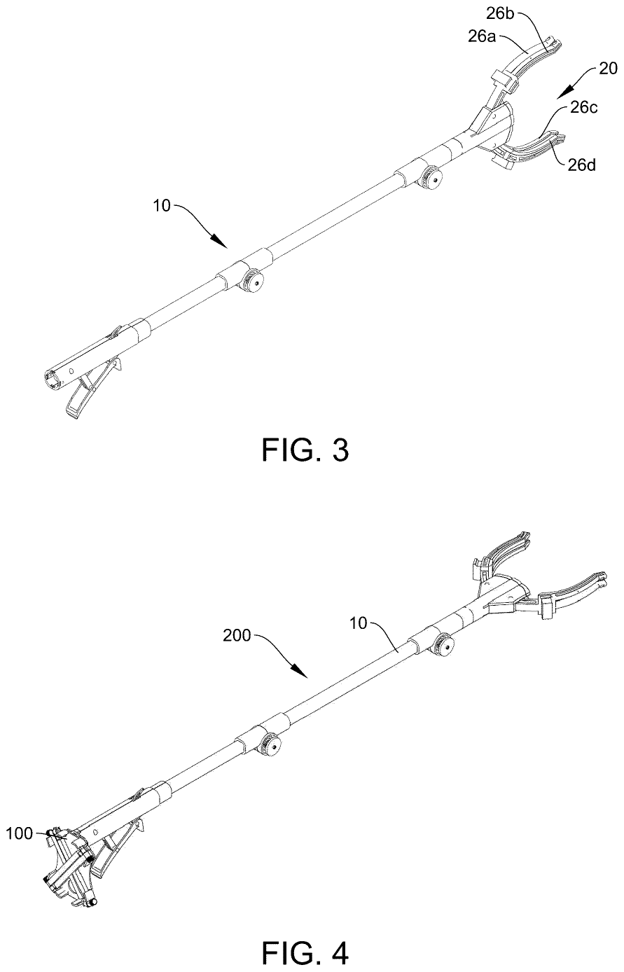

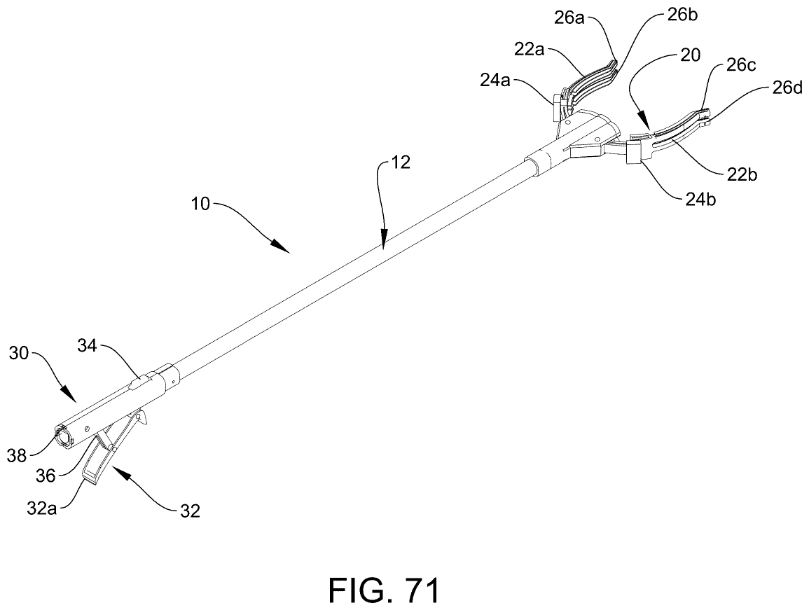

As shown in FIGS. 1 and 3, the gripping mechanism 20 can be rotatable about a longitudinal axis of the elongate body 12. The gripping mechanism 20 is coupled to the elongate body 12 via a swivel joint to allow rotational movement of the gripping mechanism 20 about the longitudinal axis. It will be appreciated that such functionality does not apply to the embodiment disclosed in FIG. 71.

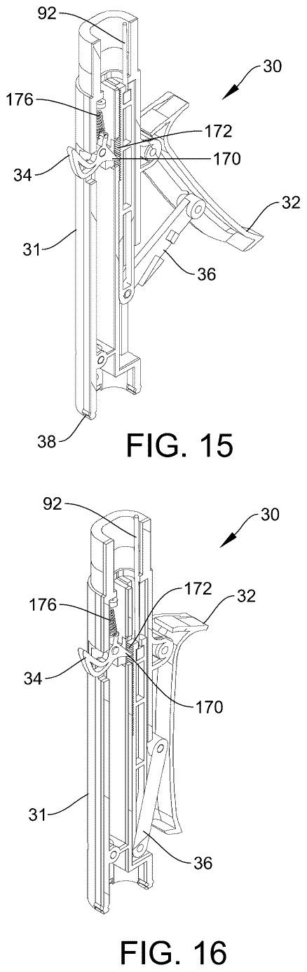

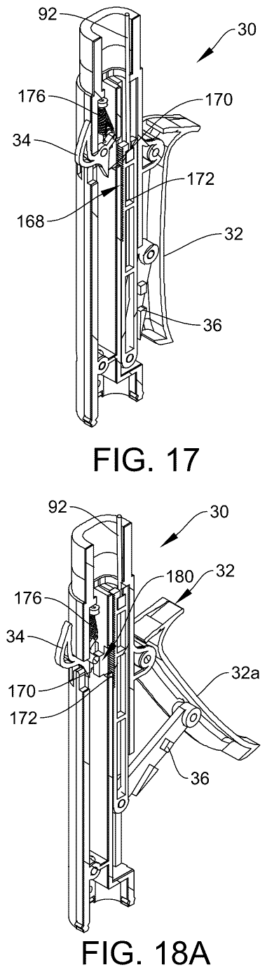

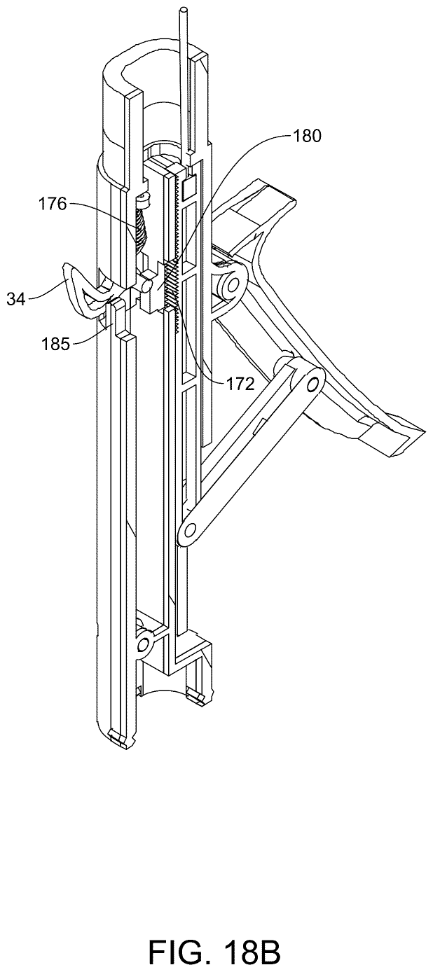

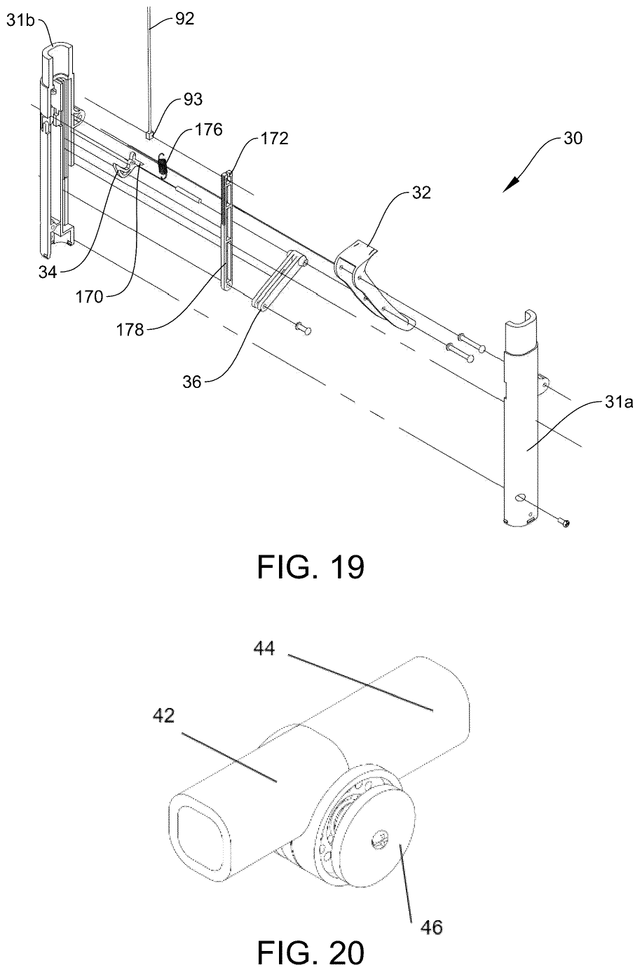

Referring to FIGS. 14 to 19 there is shown various views of the handle 30 including the trigger mechanism 32 and ratchet mechanism 168. A hand actuatable portion of a pawl member 34 of the ratchet mechanism 168 extends from a handle body 31 of the handle 30 to allow hand actuation of the ratchet mechanism 168 to an engaged and disengaged position. The handle body is formed from a pair of handle body portions 31a, 31b. The pawl 34 is operably coupled to a pawl biasing device 176 to maintain the ratchet and pawl mechanism 168 in the engaged position or the disengaged position. A first tail of the pawl biasing device 176 is secured to an inner surface of the handle and a second tail of the pawl biasing device 176 is secured to a lug of the pawl 34. As shown in FIG. 17, when the hand actuatable portion of a pawl 34 is rotated to disengage the pawl from the ratchet, the hand actuatable portion of a pawl 34 moves past a wall portion of the handle, like a “T”-shaped section, that is located adjacent the hand actuatable portion of the pawl 34. The user is then able to slide the pawl in a sideward manner from a right side of the housing to a left side of the housing along an axle supporting the pawl 34 such that the pawl 34 is located on the left side of the “T”-shaped section of the housing of the handle 30 as shown in FIG. 18A. Once the user stops pressing the hand actuatable portion of a pawl 34, the pawl biasing device 176 biases the pawl 34 to rotate in the opposite direction resulting in the hand actuatable portion of a pawl 34 being located adjacent the left side of the “T”-shaped section of the housing of the handle 30 as shown in FIG. 18B. When the pawl 34 rotates toward the ratchet 172, the sideward displacement of the pawl 34 results in the pawl 34 being supported upon and against a pawl disengagement structure 180, thus elevating the pawl 34 out of engagement with the ratchet 172. The pawl biasing device 176 biases the pawl 34 into contact with the disengagement structure 180 to maintain the pawl 34 in the disengaged position. This is advantageous as a single pawl biasing device 176 can be used to maintain the pawl 34 in both an engaged and disengaged position depending upon the operative use of the gripping tool 10. In this position in FIG. 18B, the user is free to squeeze the trigger 34A of the gripping tool 10 and can maintain a squeezing force against the trigger 34A to hold an object as the pawl 34 is disengaged from cooperation with the ratchet 172. Once the user wishes for the pawl 34 and ratchet 172 to cooperate again, the user can rotate the hand actuatable portion of a pawl 34 such that the hand actuatable portion of a pawl 34 clears the separating portion of the handle housing, slide the pawl to the right along the axle, and then release the hand actuatable portion of a pawl 34 such that the pawl biasing device 176 rotates the pawl 34 in the opposition direction so that the tail of the pawl 34 engages with the ratchet 172 in the engaged position. Thus, when the user squeezes the trigger 34A of the gripping tool 10, the pawl 34 moves along the ratchet 172 whilst remaining in engagement with the ratchet 172 in the engaged position. Therefore, if the user releases the trigger 32a, the engagement and cooperation between the pawl and ratchet restrict the gripping mechanism 20 moving from the current closed position to the open position.

The trigger mechanism 32 is operably coupled to the gripping mechanism 20 via the force transfer medium 92 and the ratchet member 178 which includes the ratchet 172 provided in the form of a rack. One end of the force transfer medium 92 includes a block 93 which locates within a hole of the ratchet member 178 to thereby couple the force transfer medium 92 to the ratchet member 178. When the pawl 34 is in the engaged position, the pawl 34 has a tail 170 having an end point which engages with the ratchet 172, such as via teeth, of the ratchet member 178 which slidably moves along a hollow section of the handle 30, thereby preventing the gripping mechanism 20 from moving to the open position under bias from the biasing device 80. In this configuration, the user does not need to continue applying a squeezing force to the trigger 32 of the trigger mechanism 32 to maintain the gripping mechanism 20 in the closed position. When the user actuates the pawl 34 to move to the disengaged position, the tail 170 of the pawl 34 disengages from the ratchet 172 of the ratchet member 178. If the user then stops applying pressure to the trigger 32 of the handle 30, the biasing device 80 of the gripping mechanism 20 withdraws the force transfer medium 92 toward the gripping mechanism 20 causing the ratchet member 178 to linearly move along the longitudinal axis and slidably moved within the elongate body 12 such that the gripping mechanism 20 moves toward the open position. It will be appreciated that the force transfer medium 92 can be coupled to ratchet member 178 via many different techniques, such as via an adhesive or the like.

The trigger 32a of the trigger mechanism 32 is pivotally connected at a first end to the handle 30. An intermediate linkage member 36 is operably coupled between the trigger 32a and the ratchet member 178. More specifically, the linkage member 36 is pivotally connected at a first end to a midpoint of the trigger 32a and at a second end to the ratchet member 178. When a user applies pressure to the trigger 32a, the trigger 32a pivotally moves which subsequently causes the intermediate member 36 to pivot, resulting in the ratchet member 178 to linearly and slidably move along the handle 30, thereby pulling the force transfer medium and closing the gripping mechanism 20. Once the pawl 34 has been moved to the disengaged position, the intermediate member 36 pivots in a reverse direction resulting in the trigger 32a also pivoting and moving to the original position.

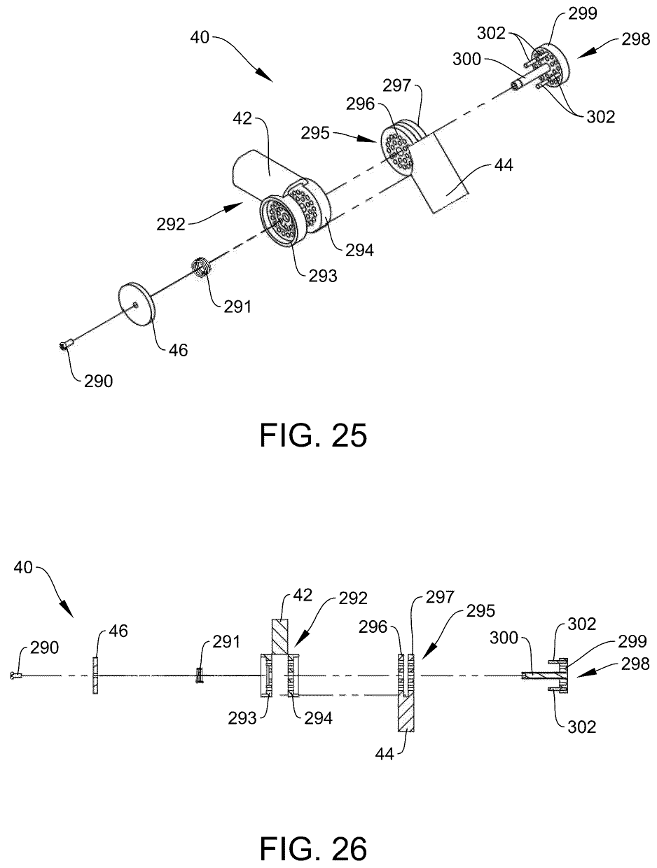

Referring to FIGS. 20 to 26 there is shown various views of a hinge assembly 40 of the gripping tool 10 as depicted in FIG. 1. It will be appreciated that the following discussion regarding the hinge assembly 40 does not apply to the embodiment disclosed in FIG. 71. In particular, the elongate body 12 of the gripping tool 10 includes a plurality of body portions 12a-c pivotally connected together via one or more hinge assemblies 40a, 40b. Each hinge assembly 40 has one or more locked positions to maintain an angular orientation between connected body portions 12a-c, and one or more unlocked positions such that at least some of the body portions 12a-c are free to pivotally move relative to each other.

As shown in FIG. 2, the one or more hinge assemblies 40 enable the gripping tool 10 to move between a stowed position such that the plurality of body portions 12a-c are foldable upon each other, and a deployed position such that the plurality of body portions 12a-c are aligned along a longitudinal axis to form the elongate body 12.

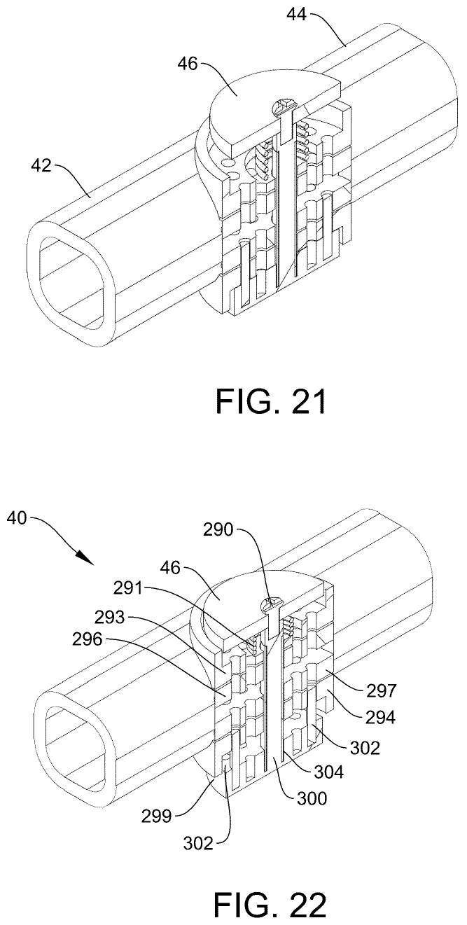

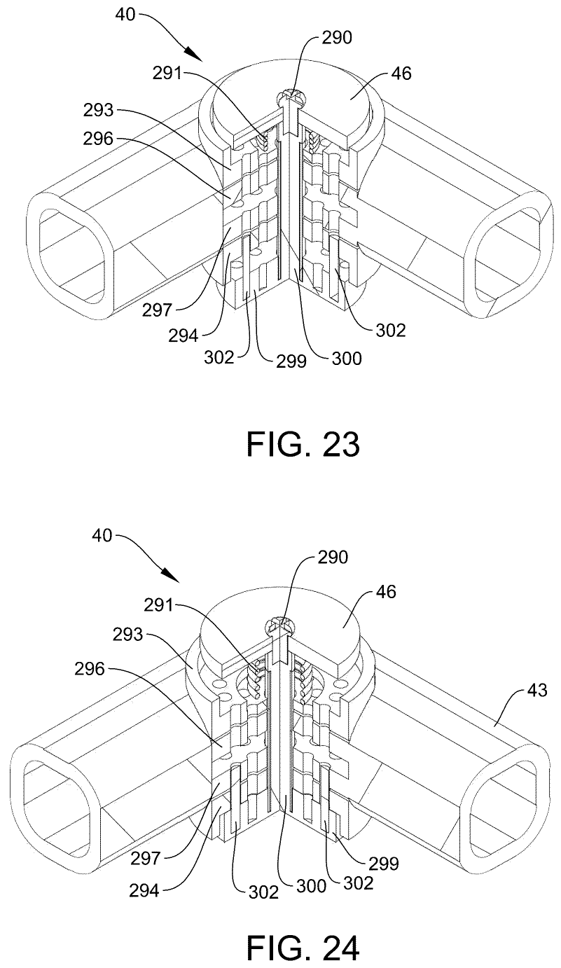

Each hinge assembly 40 includes a plurality of hinge members 293, 294, 296, 297 and a button 46 operably coupled to one or more pins 302. Each hinge member includes a plurality of holes. In one form, each hole can include a metal casing insert secured therein to provide strength to the components of the respective hinge assembly. As shown in FIGS. 21 and 24, the one or more pins 302 are locatable within at least some of the one or more holes to inhibit hinged movement of the plurality of hinged members 293, 294, 296, 297. In response to the actuation of the button 46, the hinge assembly 40 is movable between a locked position (FIGS. 21 and 24), wherein the one or more pins 302 are located within the one or more holes, and a unlocked position as shown in FIGS. 22 and 23, wherein the one or more pins 302 are withdrawn from at least some of the one or more holes to allow for hinged movement of the hinge members 293, 294, 296, 297 and the plurality of body portions 12a-c. Whilst the pins are shown with a circular cross-section, it is possible that the pins could have a different shaped cross-section, such as a square cross-section wherein the holes have a corresponding square cross-sectional profile.

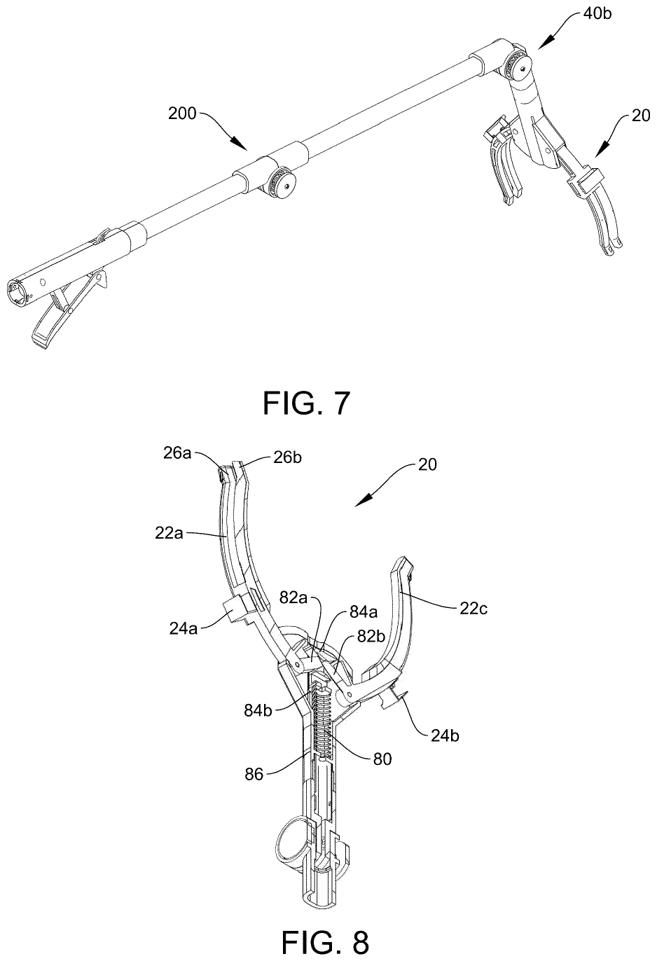

Each hinge assembly 40 includes a hinge biasing component 291, provided in the form of a spring, configured to bias the respective hinge assembly 40 from the unlocked position to the locked position in response to the one or more pins 302 aligning with at least some of the holes via the hinged movement of the plurality of body portions 12a-c. The user can hold the button 46 in the depressed position as shown in FIGS. 22 and 23 to withdraw the pins from the holes and then hingedly move the body portions 12a-c relative to each other. The user can then stop pressing the button during this hinged movement whilst the pins 302 are unaligned with the holes. It is also possible for the user to maintain pressure applied to the button during this hinged movement. When some of the holes align with the pins 302 during pivotal movement of the body portions 12a-c, the spring biases the pins to protrude through the holes to thereby move the hinge from the unlocked position to the locked position. The holes define predetermined angular orientations of the body portions 12a-c of the elongate body 12. For example, as shown in FIG. 7, one of the hinge assemblies 40 is actuated to orientate and lock the gripping mechanism 20 at a right angle (90 degrees) relative to the remaining body portions forming the elongate body 12. As shown in FIG. 1 to 7, the gripping tool 10 can include a plurality of hinge assemblies 40a, 40b. Specifically, the gripping tool 10 depicted in FIGS. 1 to 7 includes two hinge assemblies 40a, 40b which hingedly connect a lower body portion 12a including the handle 30, an intermediate body portion 12b, and an upper body portion 12c coupled to the gripping mechanism 20. The body portions 12a, 12b, 12c can be provided in the form of a metal extrusion such as aluminium tubing.

Referring more specifically to FIGS. 21 to 24, each hinge assembly 40 comprises a first hinge portion 42 including a first and second hinge member 292, 293, and a second hinge portion 44 including a third and fourth hinge member 296, 297. The first and second hinge members 292, 293 are spaced apart by a gap which receives therebetween the third and fourth hinge members 296, 297. The button 46 has a central stem 300 that is coupled thereto via fastener 290 and extends through a central hole defined by a metal casing 304, for example a metal casing insert and preferably made of steel, through all hinge members 293, 294, 296, 297. The central stem 300 extends from a rear plate 299. The rear plate 299 includes has the plurality of pins 302 extending therefrom and extend through one of the hinge members 297 of the first hinge portion 42 and one of the hinge members 294 of the second hinge portion 44 in the locked position. In the unlocked position, the pins 304 only extend through one of the hinge members 297 of the first hinge portion 42, such that the second hinge portion 44 is free to rotate relative to the first hinge portion 42 about the central stem 300. The hinge biasing component 292 is located in a cavity defined by the button 46 and substantially enclosed by one of the members 293 of the first hinge portion 42. Each hinge portion 42, 44 includes a coupling component 43 to couple the respective hinge portion to a body portion 12a-c of the elongate body 12.

The hinge assembly may be preferably made of metal. However, it will be appreciated that it is possible for at least some of the hinge assembly to be made of moldable (e.g., injection moldable) materials. However, as highlighted above, the casing 304 which houses the central stem through a central hole through the hinge members is preferably made of a strong metal such as steel to provide overall strength to the hinge when other components of the hinge are made from non-metal materials. However, in an alternate arrangement, the central stem may comprise a metal inner core surrounded by a moldable material.

Referring to FIGS. 27 to 34 there is shown an example of a stand 100. In particular, the handle 30 of the gripping tool 10 includes a releasable coupling mechanism 38 for releasably coupling the gripping tool 10 to the stand 100. The releasable coupling mechanism 38 is preferably a snap fitting coupling mechanism. The stand 100 is configured to be releasably coupled to the releasable coupling mechanism 38 of the handle 30 to support the gripping tool 10. As seen most clearly in FIG. 33B, the coupling mechanism 3604 of the stand 100 includes a plurality of prongs 3320, 3330 which extend upwards from the stand body 3602, wherein inner prongs 3330 of the releasable coupling mechanism 3604 protrude within a cavity of the handle 30 and outer prongs 3320 of the releasable coupling mechanism clamp about the outer surface of the handle to thereby releasably couple the stand 100 to the gripping tool 10. A button 3310 is provided at the end of the handle which can be pressed by the user to disengage the gripping tool 10 from the stand 100. In particular, the pressing of the button 3310 causes a portion of the wall of the handle to resiliently flex to allow at least some of the protrusions to disengage from at least some of the grooves, thereby allowing the gripping tool 10 to be disengaged from the stand 100.

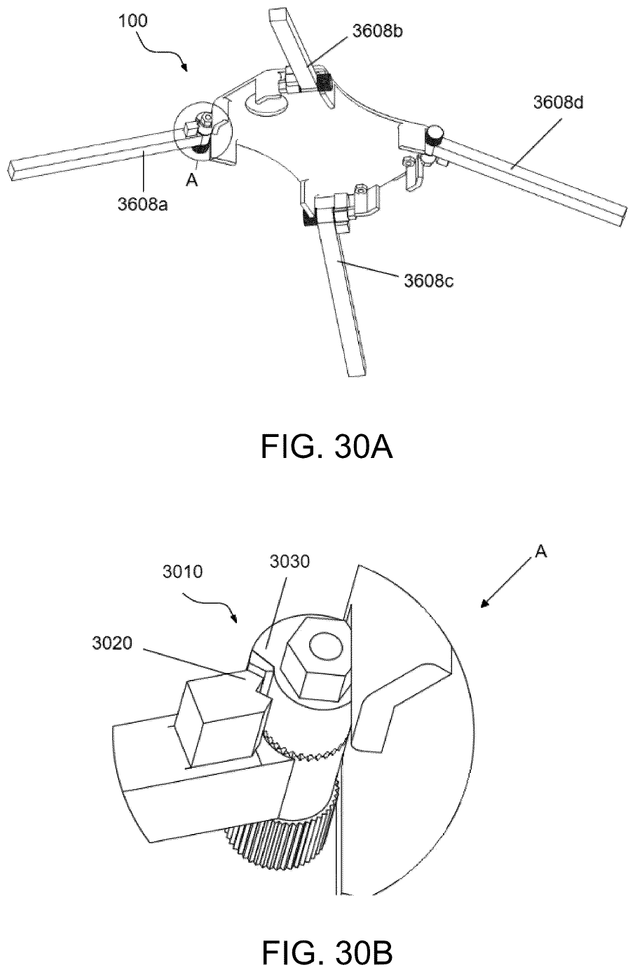

The stand 100 has a plurality of legs 3608a-d which hingedly move between a stowed position, as shown in FIGS. 27 to 29, and a deployed position as shown in FIGS. 30 to 33B. The legs 3608a-d are hingedly connected to the stand body 3602 via a respective plurality of fasteners 3606. The fasteners can be provided in the form of bolts which couple to nuts. In one form, the fasteners can be provided as finger tightenable members 3616a-d to engage with threaded members. The finger tightenable members 3616a-d can be tightened and loosened by a user to maintain the legs of the stand 200 in a stowed or deployed position as discussed in more detail below.

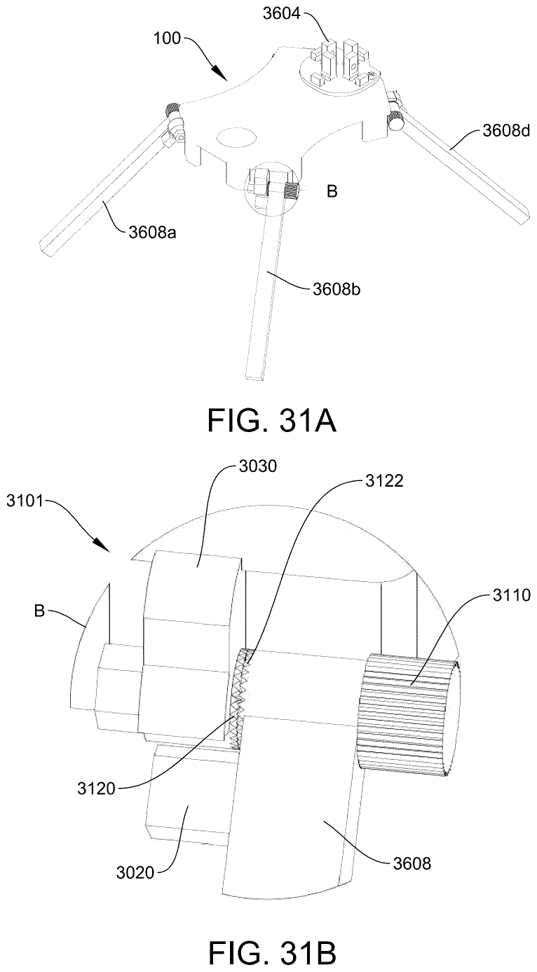

Referring to FIGS. 30A-33B, the stand 100 includes a plurality of hinge barrels 3030, wherein each hinge barrel 3030 is configured to receive therethrough the stem of a respective bolt 3616a-d to thereby hingedly couple the legs to the stand body. As shown in FIG. 31B, each hinge barrel 3030 includes an engagement surface 3120 which is located adjacent a complimentary engagement surface 3122 of a coupling end of the respective leg 3608. When the bolt 3616 has been loosened by the user, the engagement surfaces 3120, 3122 do not mesh together, thereby allowing the respective leg 3608 to freely pivot relative to the body of the stand. However, once the desired position (deployed or stowed) has been achieved with a particular leg, the user can finger tighten the bolt by rotating the bolt head 3110 thereby causing the engagement surface 3122 of the coupling end of the leg 3608 to mesh and engage with the engagement surface 3120 of the hinge barrel 3030, thereby releasably locking the leg into the desired position.

Each leg hinge 3101, as shown in FIG. 31B, includes a stop mechanism 3010. As shown in FIGS. 30A and 30B, each leg 3608 includes a protruding stop member 3020 located adjacent to the coupling end of the leg 3608. When the free end of each leg 3608 is rotated away from to the stand body, the protruding stop member 3020 eventually contacts a stop surface 3030 of the hinge barrel 3030 thereby defining a fully deployed position of the respective leg 3608. The bolt head 3110 can then be finger tightened to thereby lock the leg into the fully deployed position. When the respective leg is to be moved to the stowed position, the holt head 3110 can be finger loosened such that the leg is free to hingedly move back to the deployed position. The user can then finger tighten the bolt head 3110 again to lock the leg in the stowed position.

In one form, the gripping apparatus 200 including the gripping tool 10 coupled to the stand 100 can be used to hold various objects. For example, the gripping tool 10 can be actuated to hold a smartphone to take a photograph. The trigger mechanism 32 can be actuated to hold the smart phone by the gripping mechanism 20 whilst the ratchet and pawl mechanism 168 can maintain the trigger mechanism 32 in the closed position so that the user does not need to maintain a squeezing force upon the trigger mechanism 32.

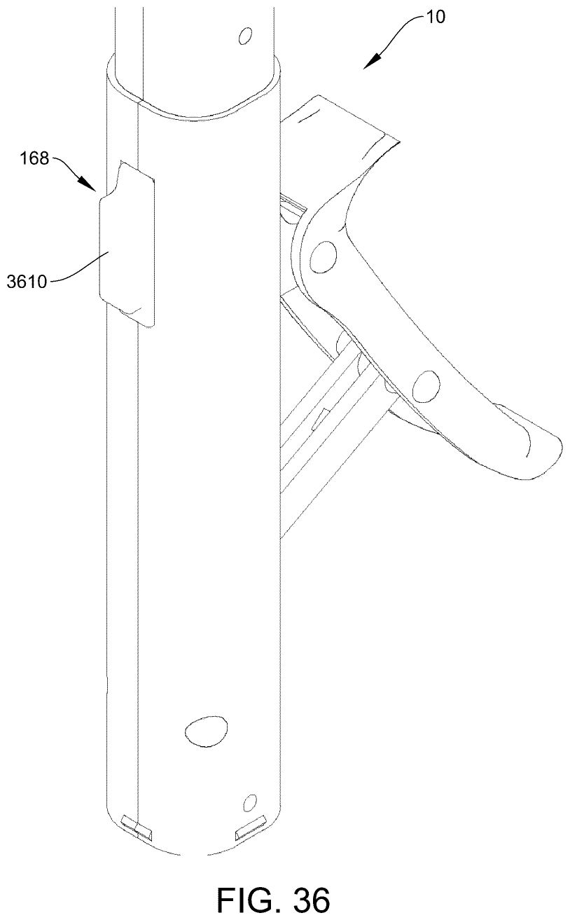

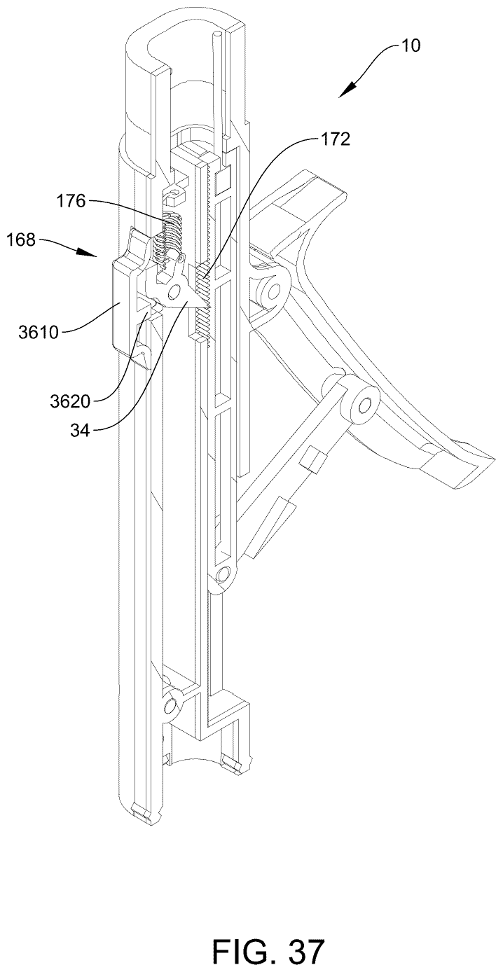

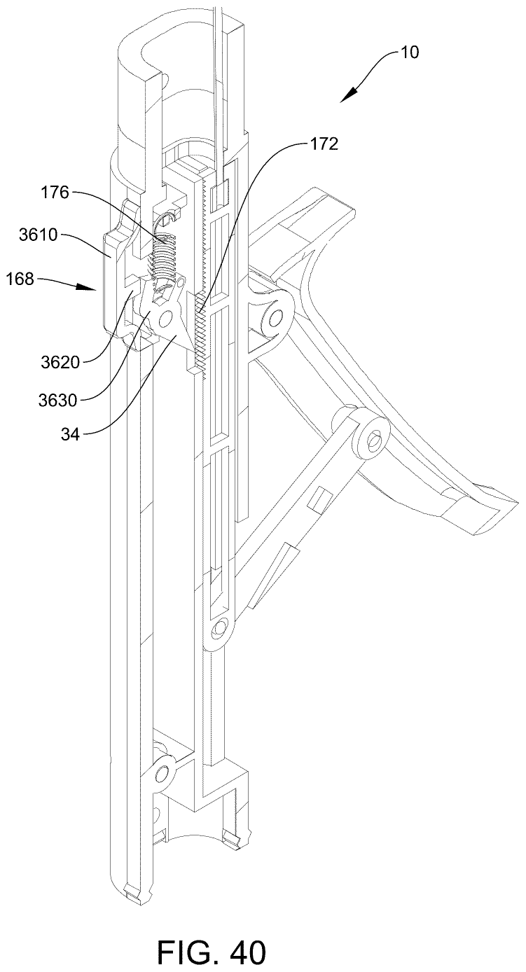

Referring to FIGS. 36 to 41 there is shown an alternate ratchet mechanism 168 for the gripping tool 10 of FIG. 1. In particular, the gripping tool 10 includes a slidable button assembly including a slidable button 3610 to cooperate with and rotatably actuate the pawl 34 of the ratchet and pawl mechanism 168. As will be appreciated from the embodiment of the gripping tool 10 described in relation to FIG. 1, the pawl 34 is configured to be rotated to engage and disengage with the ratchet 172. A portion of the pawl 34 which extends outwardly from the handle wall can be rotated by the user. However, in some instances it can be ergonomically advantageous to provide a slidable actuation of the pawl 34. In the embodiment shown in FIGS. 36 to 41, the slidable button 3610 of the slidable button assembly allows for a transfer of the slidable motion of the button 3610 to the pawl 34 to cause rotational actuation thereof, thereby actuating the pawl 34 to either the engaged or disengaged position. In certain forms, the button 3610 can be slidably actuated in a direction parallel to the longitudinal body axis.

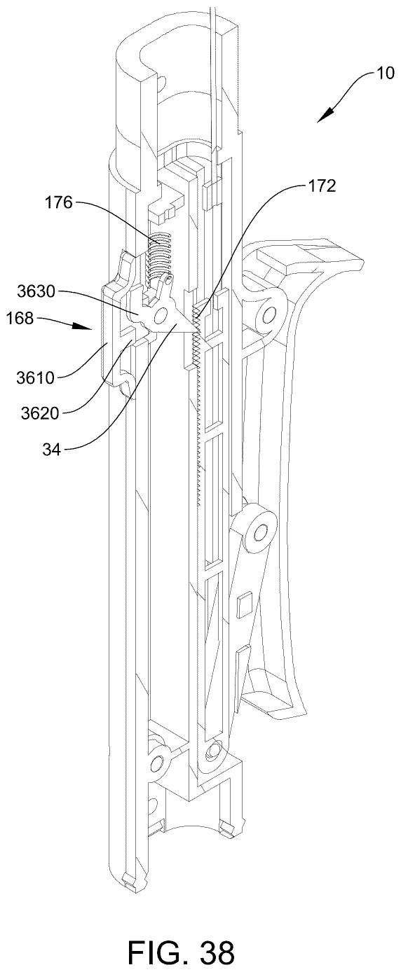

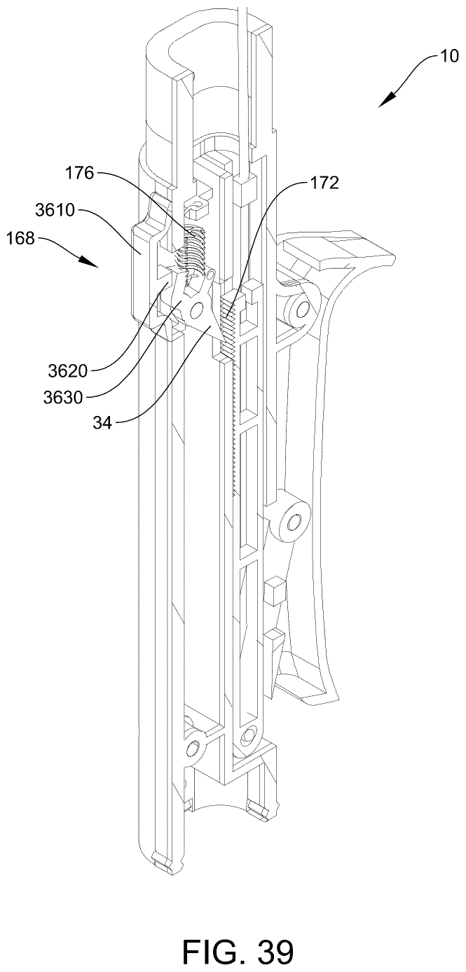

More specifically, referring to FIG. 38 there is shown the ratchet mechanism 168 of the gripping tool 10 in the engaged position. The pawl 34 includes an arm portion that extends partially outwardly through a hole provided in the wall of the handle housing. The arm portion has a rounded section which an actuating finger 3620 of the slidable button 3610 cooperates therewith when moving from the engaged to disengaged position. As shown in FIG. 39, the slidable motion of the slidable button 3610 from an engaged button position to a disengaged button position causes the actuating finger 3620 to contact the round section of the arm portion such that the arm portion rotates about a pawl mounting pin, thereby disengaging the pawl 34 from the ratchet 172. The slidable button 3610 is moved by the user against the bias of the pawl biasing device 176. In one form, once the user releases contact with the slidable button 3610, the pawl biasing device 176 urges the pawl 34 to counter-rotate such that the slidable button 3610 slides in an opposite direction to that caused by the user and the pawl 34 re-engages with the ratchet 172 thereby placing the ratchet mechanism 168 in the engaged position. However, in other arrangements, the slidable button may be maintained in the disengaged position despite the user removing contact with the button, such that the ratchet mechanism moves to the engaged position in response to the user slidably moving the button from the disengaged button position to the engaged button position.

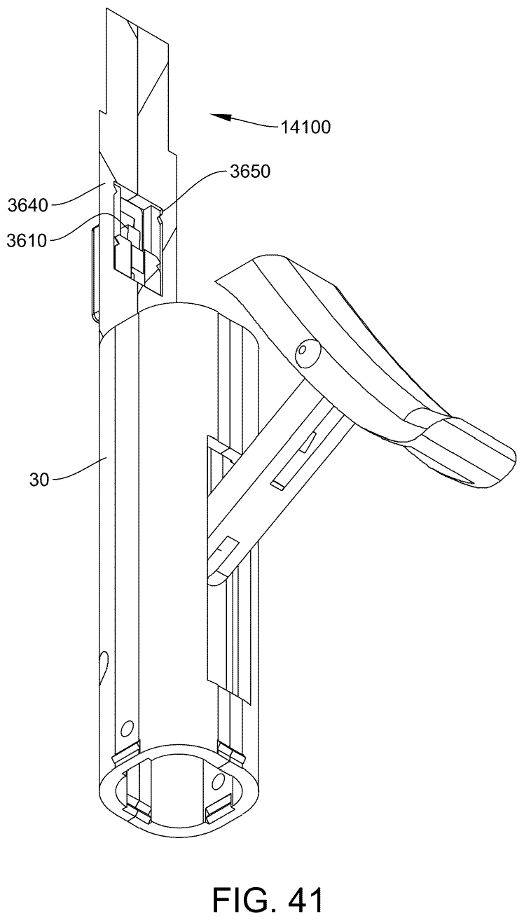

As shown in FIG. 41, the slidable button assembly 4100 can be releasably coupled to the handle 30. In particular, the slidable button assembly 4100 can include a frame insert 3640, supporting the slidable button, which snap fittingly engages with a recess in the handle housing to locate the slidable button assembly 4100 in a position where the slidable button 3610 is cooperative with the pawl 34 upon actuation. The frame insert 3640 includes a central aperture 3650 to allow for the actuating finger 3620 of the slidable button 3610 to cooperate with the arm portion of the pawl 34.

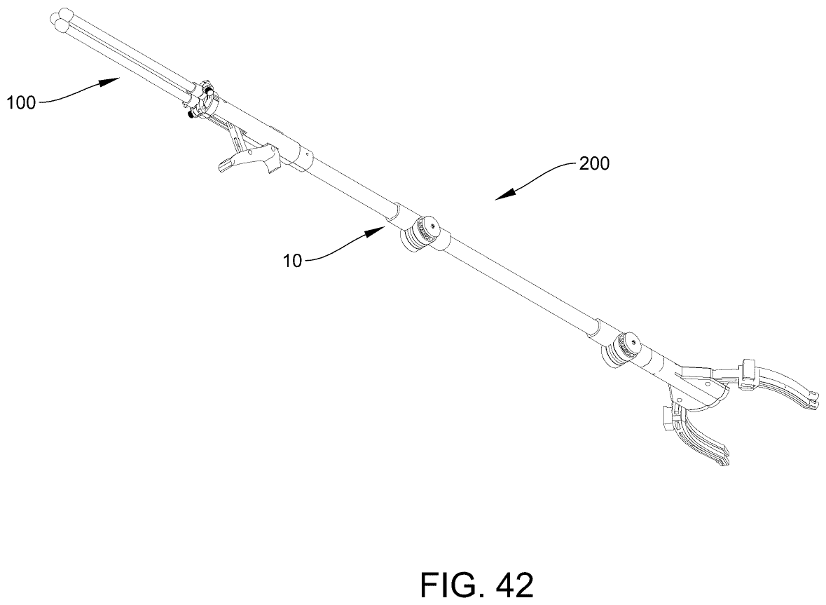

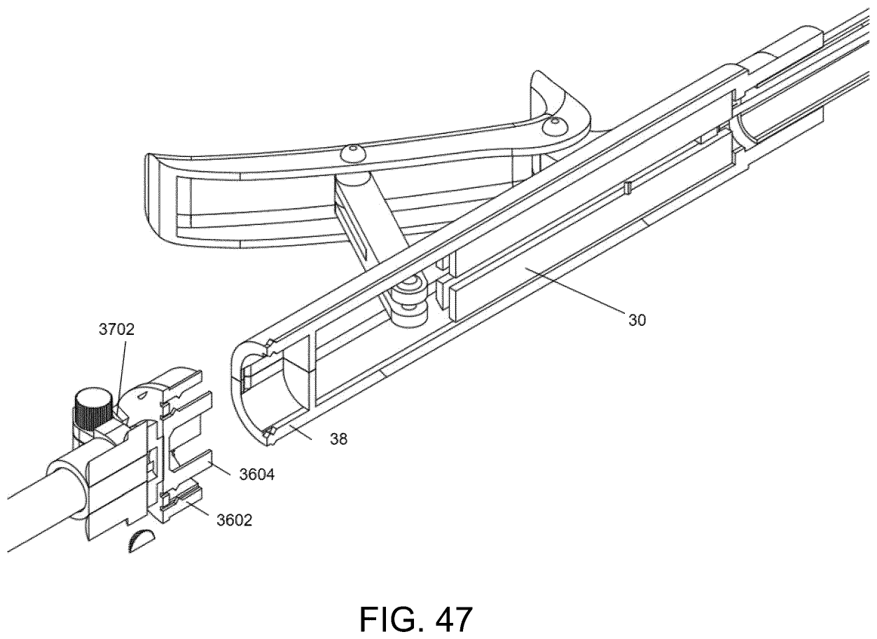

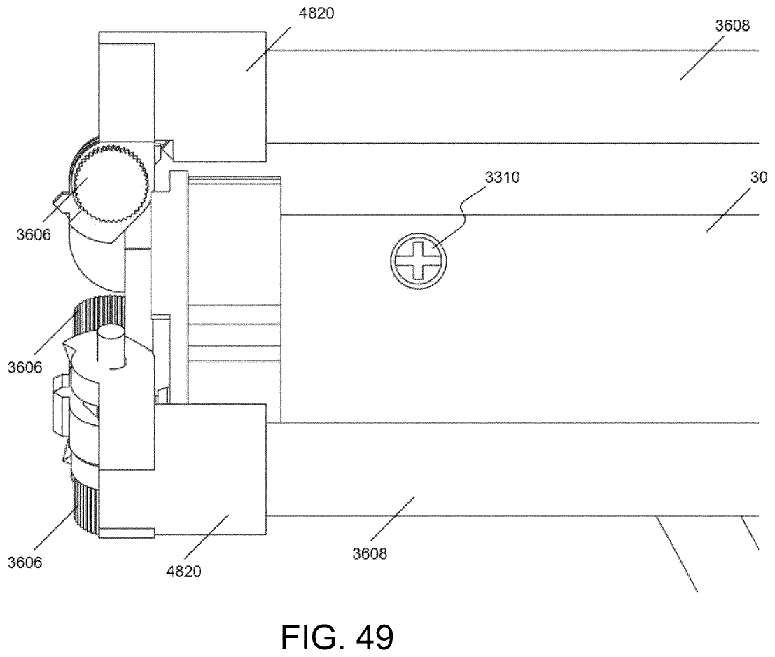

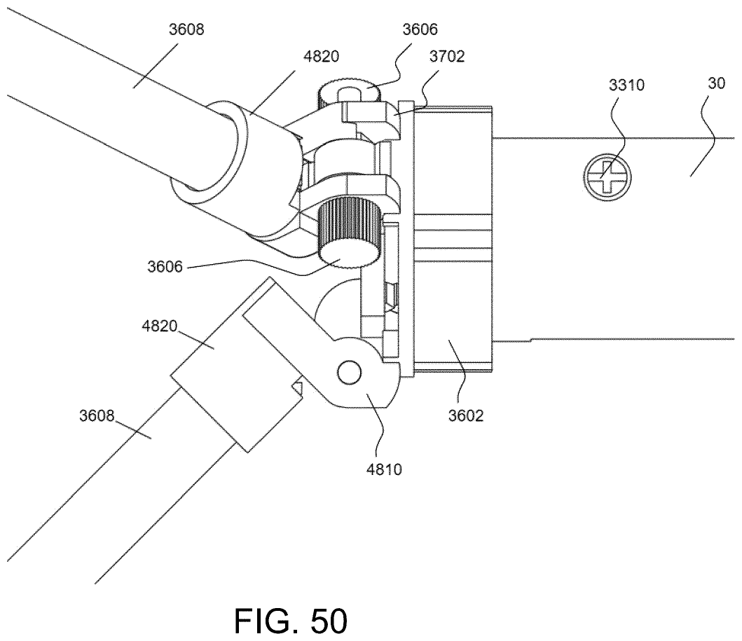

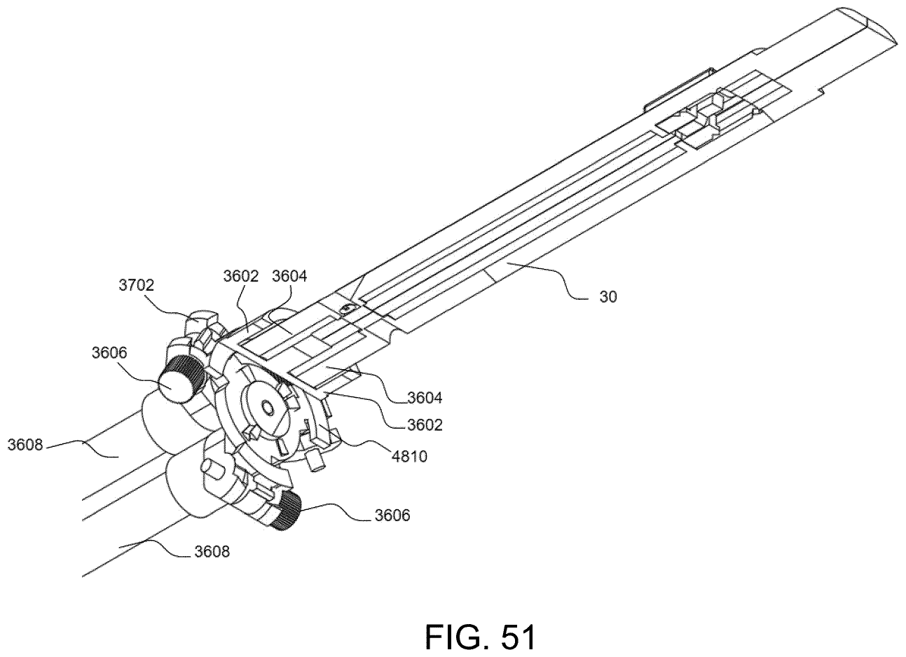

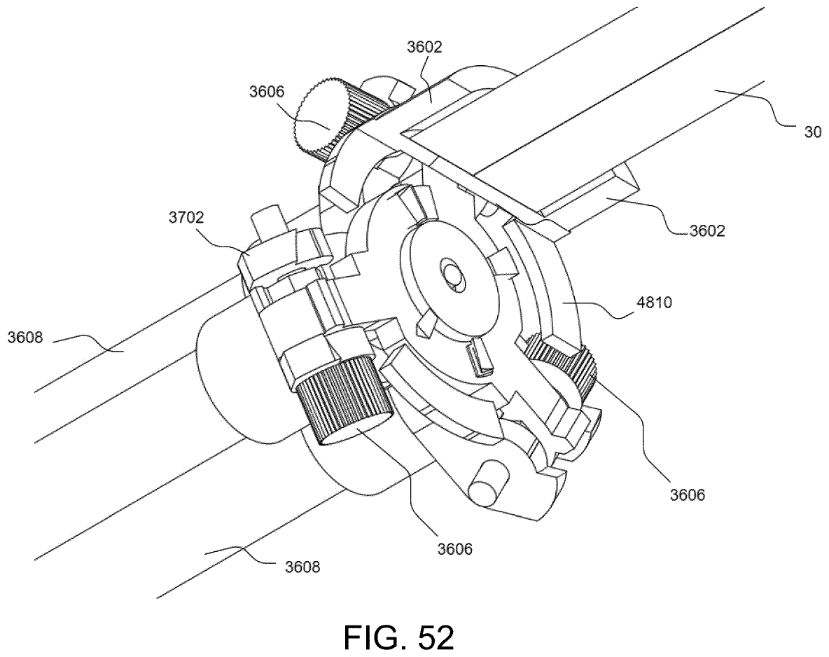

Referring to FIGS. 42 to 52 there is shown a further example of the apparatus 200 including the gripping tool 10 described in relation to FIG. 1 or FIG. 36, and a further example of a stand 100 which is releasably coupled to the gripping tool 10 via a releasable coupling mechanism 38.

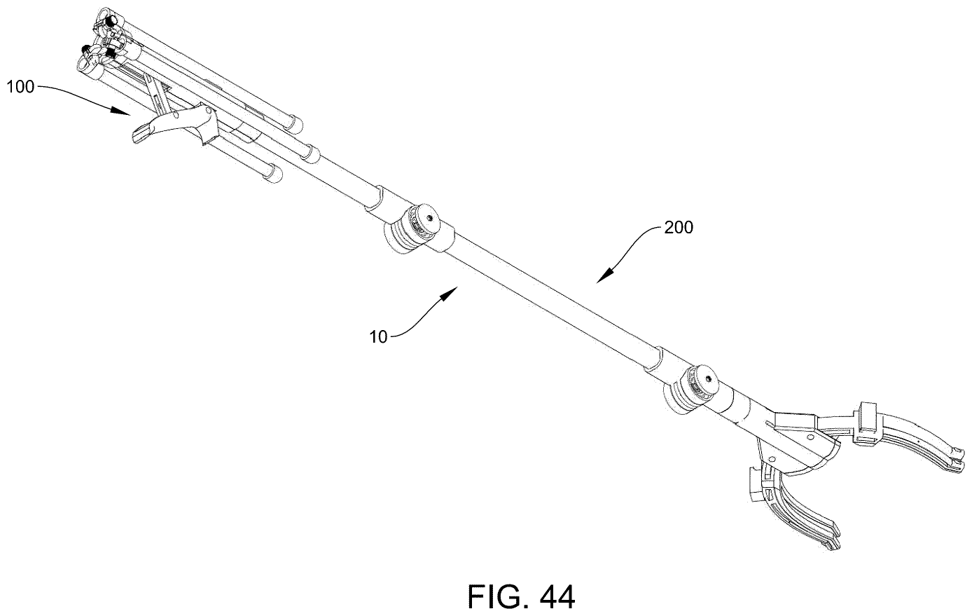

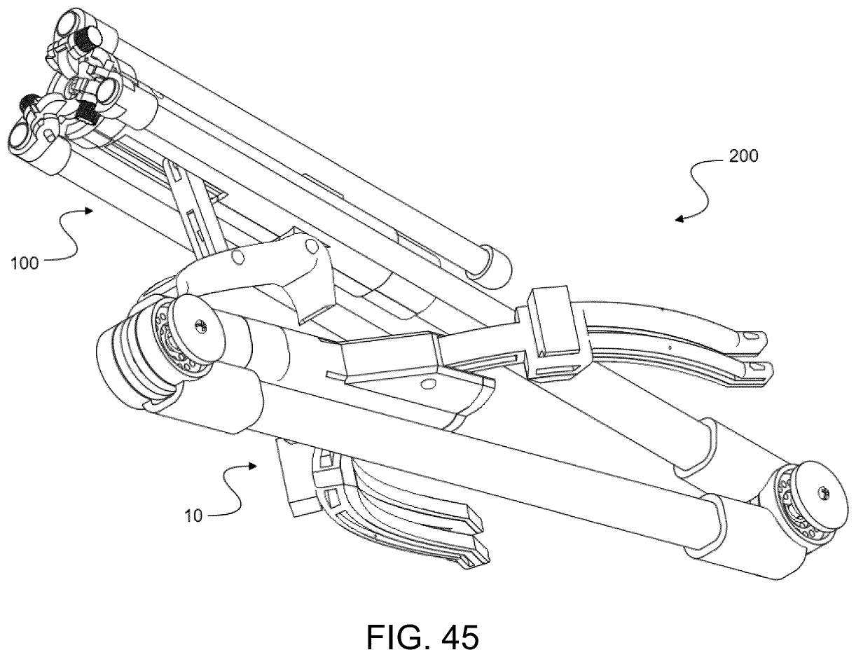

As shown in FIGS. 42 and 44, the stand 100 has two different stowed positions. The stand 100 has a tripod configuration including three legs 3608. In a first stowed position, as shown in FIG. 42, the legs 3608 are substantially parallel with the elongate body of the gripping tool 10 such that the feet 5300 of the legs 3608 extend away from the gripping mechanism 20. In addition, the stand 100 has a second stowed position, as shown in FIG. 44 where the legs 3608 hingedly rotate to at least partially surround the handle 30 of the gripping tool 10. As shown in FIG. 44, the feet 5300 of the legs 3608 extend toward the gripping mechanism 20. As can be seen in FIG. 45, the elongate body can also be moved to a stowed position such that the apparatus 200 has a compact footprint.

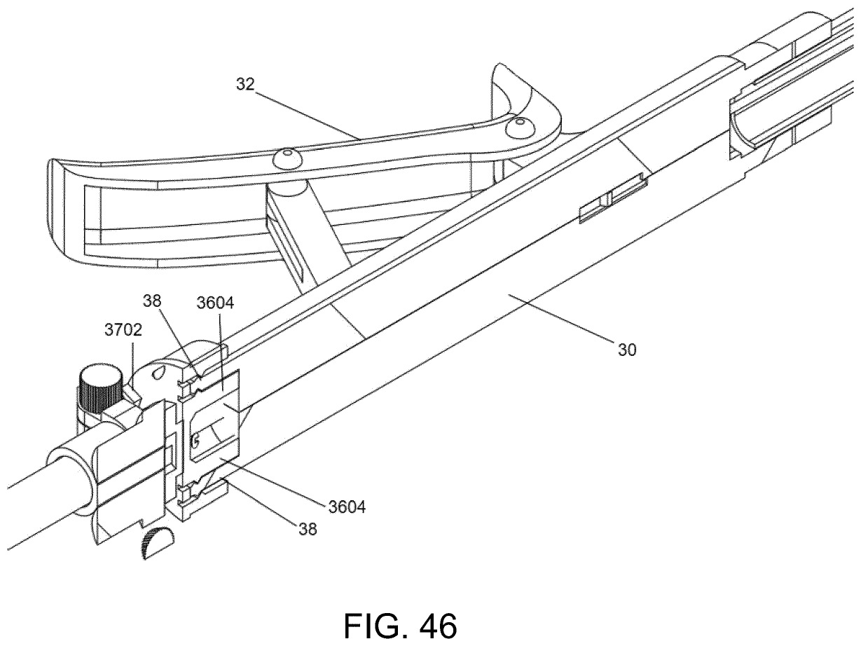

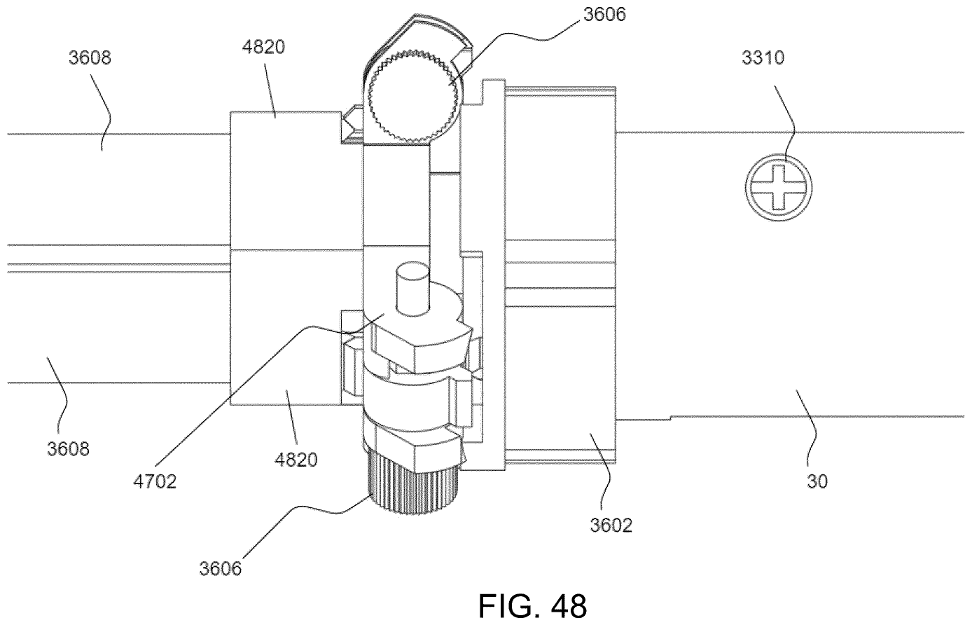

Referring to FIG. 46 to 48, the releasable coupling mechanism 38 of the handle includes a cavity to releasably receive a complimentary protruding insert section 3604 extending from a base of the stand. The protruding insert section 3604 preferably is configured to snap fittingly engage with the walls defining the cavity of the releasable coupling mechanism 38 to releasably couple the stand 100 to the handle 30 of the gripping tool 10. As shown in FIG. 48, the handle 30 has a button 3310 which can be pressed by the user to resiliently disengage the protruding insert 3604 from the walls defining the cavity, thereby allowing the stand 100 and the gripping tool 10 to be releasably separated.

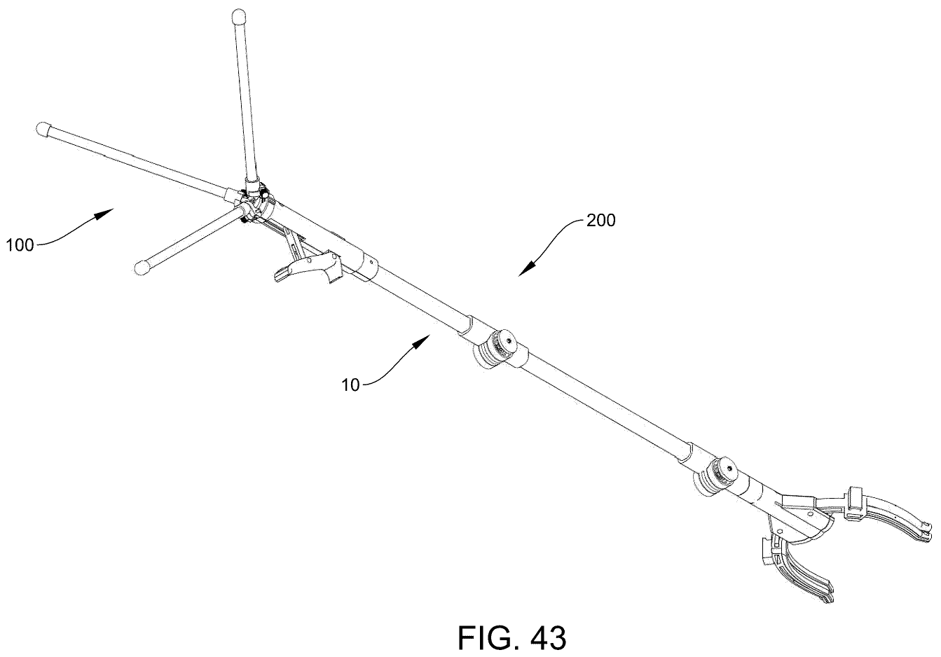

Each hinge mechanism of the legs 3608 includes a bolt 3606 acting as a hinge pin which can be hand-actuated to tighten or loosen the hinged movement of the respective leg 3608. When one of the bolts 3606 is hand-loosened, the respective leg 3608 is free to hingedly rotate to either of the stowed positions shown in FIG. 42 or 44 or the deployed position as shown in FIG. 43. The respective bolt 3606 can then be re-tightened by hand to lock the respective leg 3608 into position.

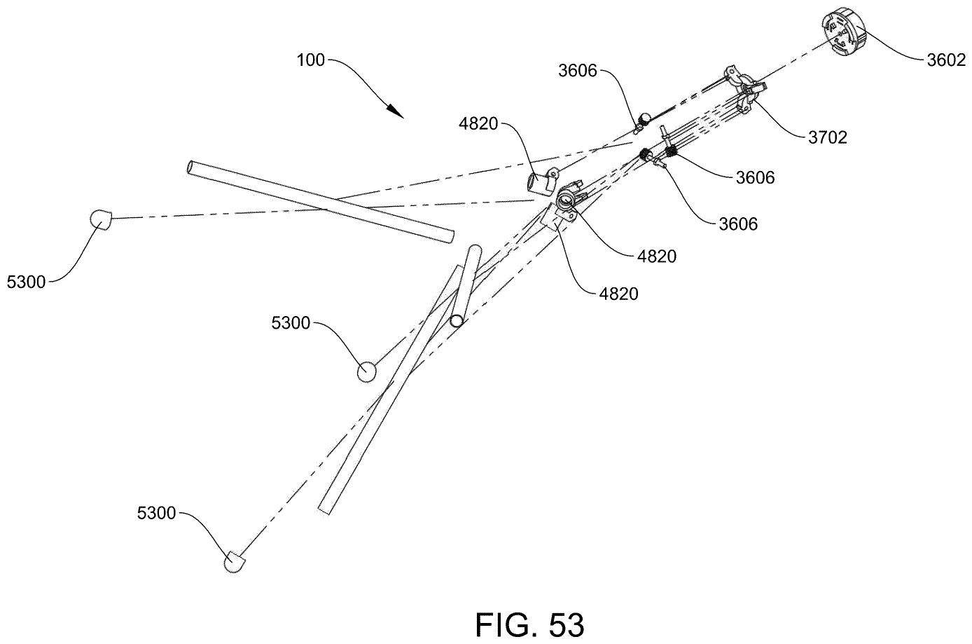

Referring to FIG. 53 which shows an exploded schematic of the stand 100 which is isolated from the remainder of the apparatus 200, the stand 100 includes a body 3608 which has a protruding portion 3604 for releasable coupling with the releasable coupling mechanism 38 of the handle of the gripping tool. The body 3608 has an underside surface including holes for securing a hinge mounting structure 3702. A plurality of leg supports 4820 are hingedly coupled, by a respective bolt 3606, to the hinge mounting structure. Each leg 3608 is secured within each leg support 4820.

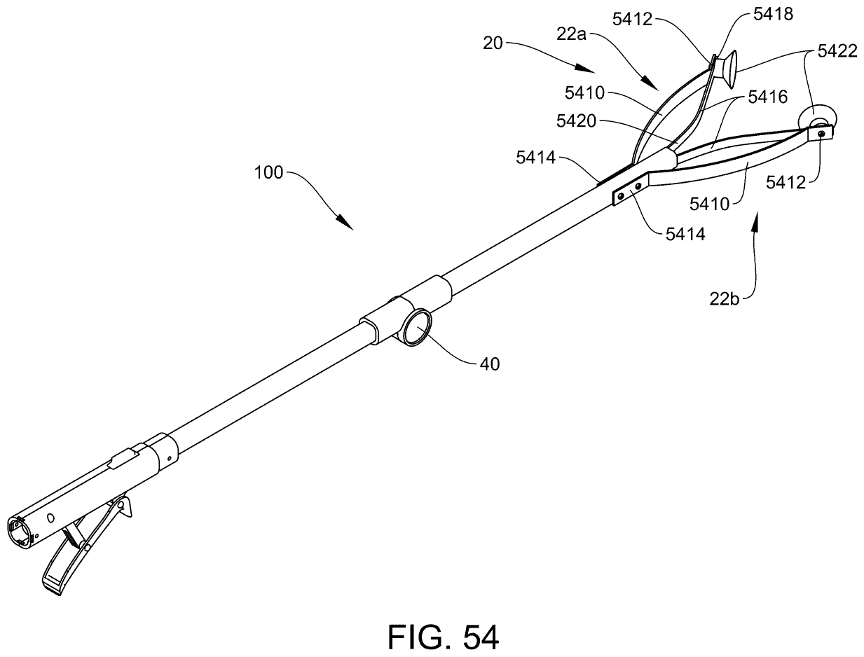

Referring to FIG. 54, there is shown a schematic view of an alternate example of a gripping tool 100 including an alternate gripping mechanism 20. In particular, the gripping mechanism 20 includes a pair of outer gripping arms 5410 coupled to a pair of inner gripping arms 6416. The pair of outer and inner gripping arms 5410, 5416 are resilient. A first end 5412 of each outer gripping arm 5410 is coupled to a first end 5418 of a respective inner gripping arm 5418. The first end 5418 of each inner gripping arm 5416 has secured thereto a suction cap 5422 to adhere to a nonporous surface of an object to be gripped. A second end 5414 of each outer gripping arm 5410 is coupled to the elongate body. A second end of the inner gripping arms 5420 are operably coupled to the force transfer medium 92. As the force transfer medium 92 is withdrawn within the elongate body via actuation of the trigger mechanism, at least a portion of the inner gripping arms 5416 are withdrawn within a hollow section of the elongate body, resulting in the outer gripping arms 5410 resiliently bending such that the first ends 5412 of the outer gripping arms 5410 moving toward each other resulting in the suction caps 5422 releasably adhering to the nonporous surface of the object to be gripped.

The gripping tool of FIG. 54 can include a hinge assembly 40 which has a limited number of locked positions. In particular, the hinge assembly 40 can include a 180-degree locked position as shown in FIG. 54 and a 0-degree (i.e., folded position where body member 12a is substantially parallel to body member 12b). It will be appreciated that in order to achieve such a hinge assembly, the hinge assembly of FIGS. 20 to 26 would include less holes to define only these two locked positions.

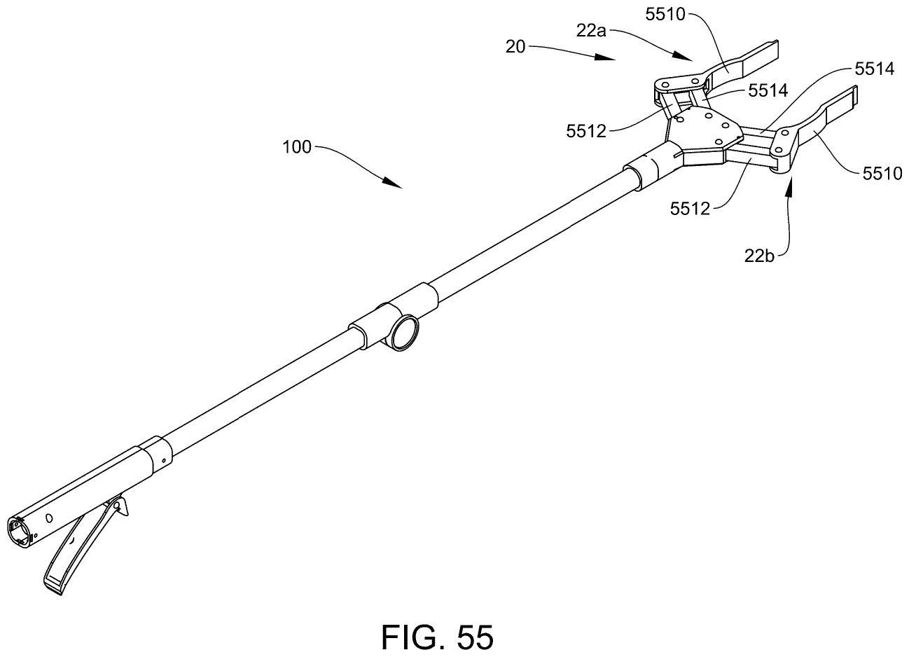

Referring to FIG. 55, there is shown a schematic view of a further alternate example of a gripping tool 10 including a further alternate gripping mechanism 20. In particular, the gripping mechanism 20 includes a pair of opposing gripping arms 22a, 22b. A first end of each gripping arm 22a, 22b provides the respective gripping end. The opposing second end of each gripping arm 22a, 22b is pivotally coupled to a first rotatable member 5512 which is also operably coupled to the force transfer medium 92. The gripping mechanism 20 also includes a pair of second rotatable members 5514, wherein each second rotatable member 5514 is operably coupled to the force transfer medium 92 and is pivotally attached to a midpoint of a respective one of the first rotatable members 5510. When the force transfer medium 92 is withdrawn within the elongate body in response to actuation of the trigger mechanism, the second rotatable arms rotate causing the gripping ends of the first gripping members 22a, 22b to rotate inwardly toward each other to grip the object to be gripped.

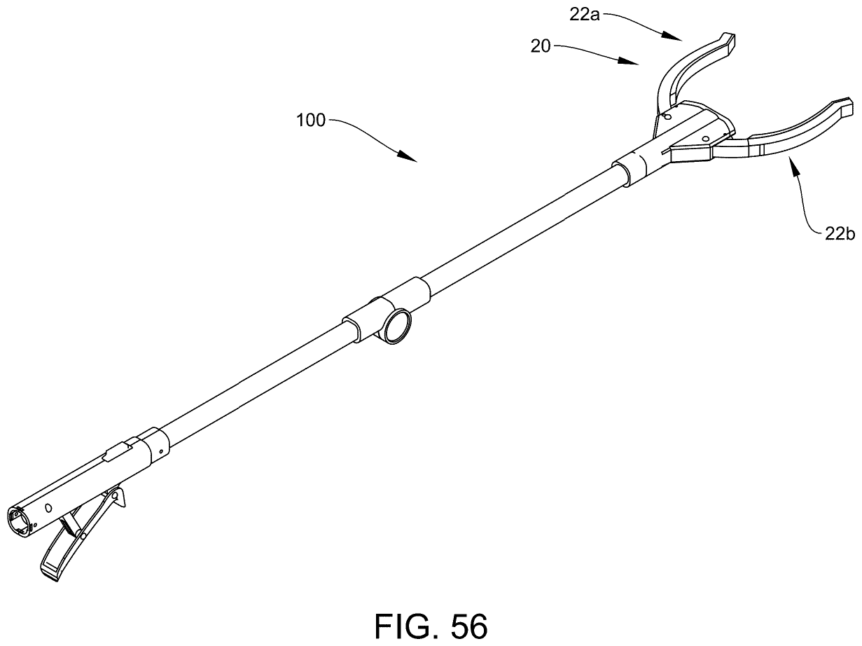

Referring to FIG. 56, there is shown a schematic view of a further alternate example of a gripping tool 10 including a further alternate gripping mechanism 20. The gripping mechanism 20 includes a pair of gripping arms 22a, 22b. In contrast to the embodiment disclosed in FIG. 1, the gripping arms 22a, 22b have an integral structure and do not interleave, unlike the embodiment of FIG. 1, when the trigger mechanism is actuated.

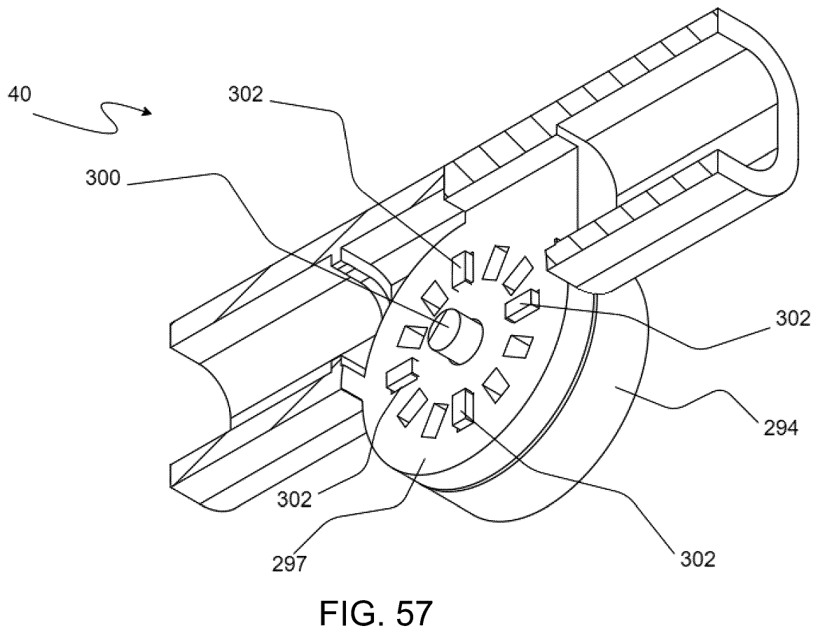

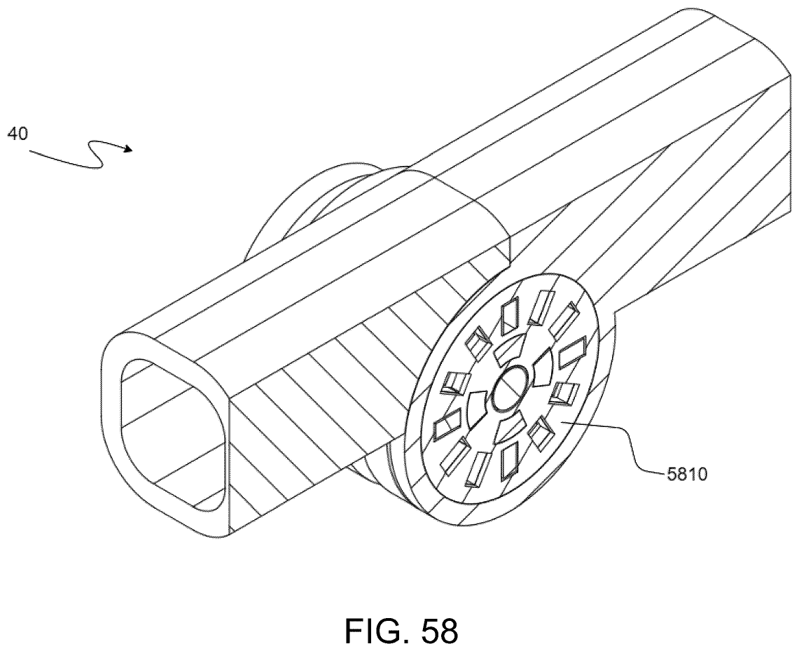

Referring to FIG. 57, there is shown a cross-sectional view of an alternate hinge assembly 40 of the gripping tool 100 of FIG. 1. In particular, the pins 302 which extend from the hinge member 294 which support the central stem 300 have a rectangular cross-sectional profile. The neighbouring hinge member 297 includes a plurality of rectangular holes which are radially located relative to the central hole receiving the central stem 300 therethrough. Advantageously, the non-circular cross-sectional profile of the pins 302 and the corresponding non-circular holes provided by the neighbouring hinge members 297 of the hinge assembly 40 have been found to increase the strength of the hinge assembly 40.

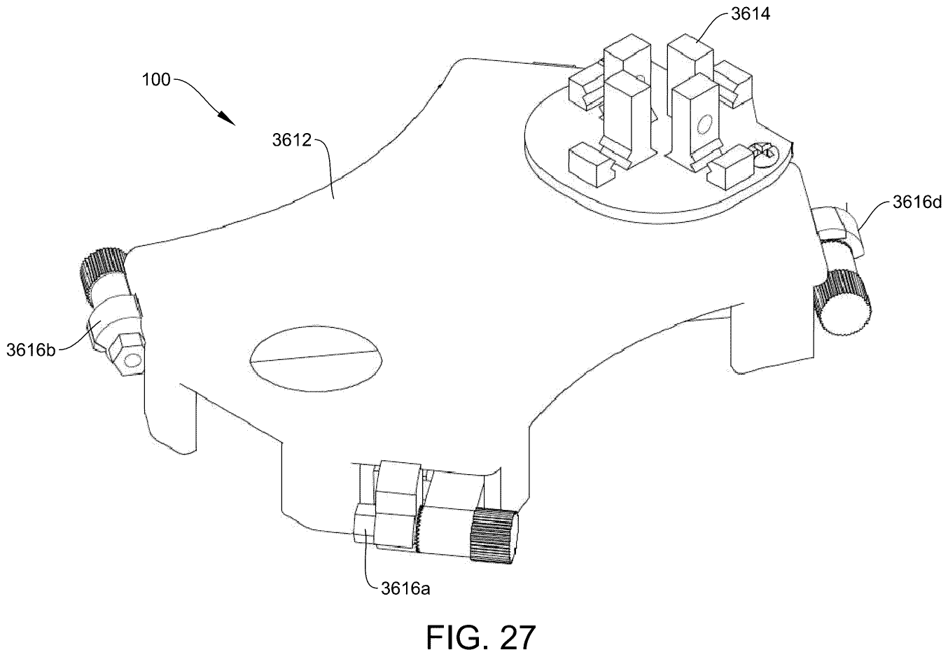

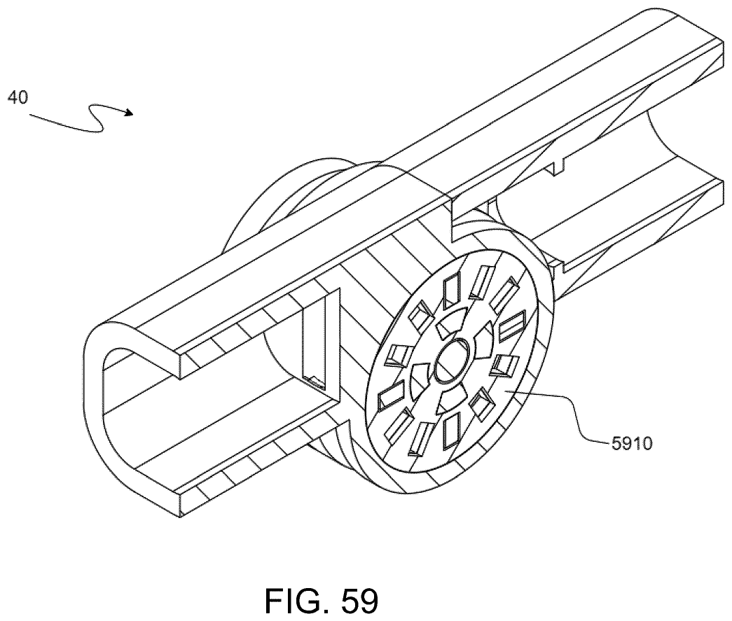

Referring to FIGS. 58 and 59, there is shown cross-sectional views of the hinge assembly 40 of FIG. 57. In particular, the hinge assembly 40 includes one or more plate inserts 5810, 5910 that are located within or adjacent to one or more of the hinge members of the hinge assembly. FIG. 58 shows a first plate insert 5810 that is located within a cavity defined by or located adjacent to an outer knuckle defined by the hinge member portion 293 of hinge member 42 (see FIG. 26). In addition, as shown in FIG. 59, a second plate insert 5910 is located within a cavity defined by or located adjacent to an inner knuckle defined by the hinge member portion 296 of hinge portion 44. The plate inserts 5810, 5910 are preferably made from a metal, such as steel, to provide additional strength to the hinge assembly 40. The plate inserts 5810, 5910 include a plurality of radially located holes as well as a central hole corresponding to the pin and central stem configuration to allow for the central stem 300 to protrude therethrough and the pins 302 to protrude therethrough and be withdrawn when moving between the locked position and the unlocked position.

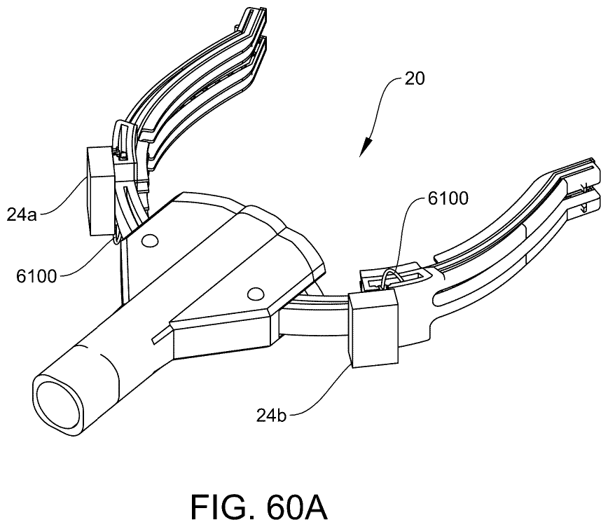

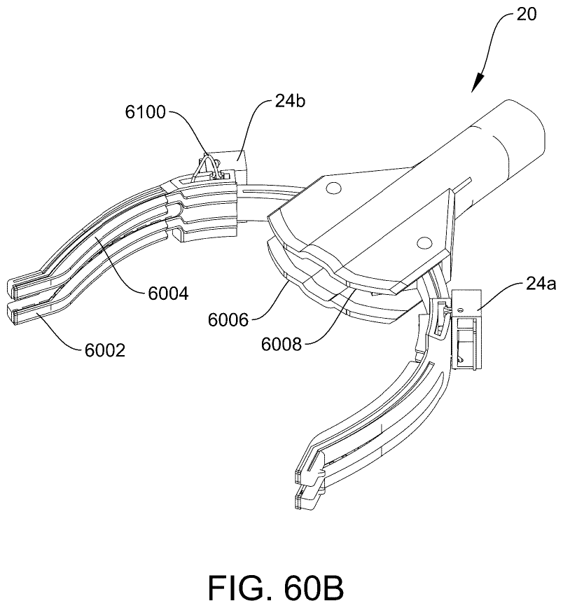

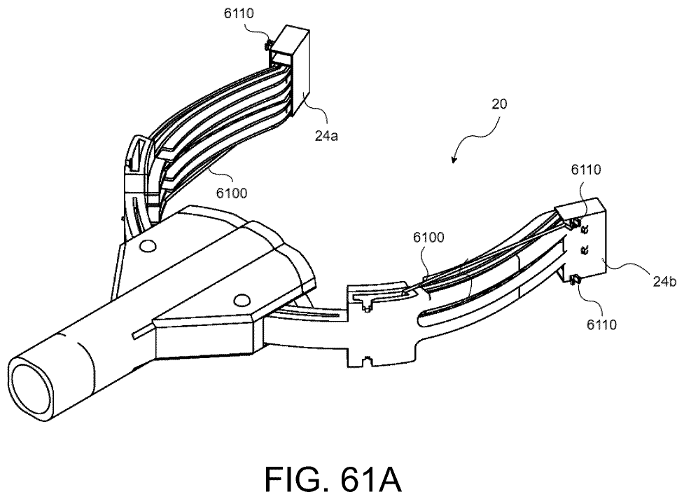

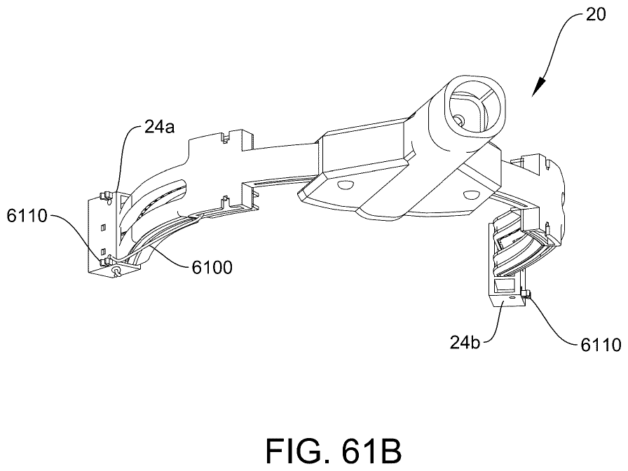

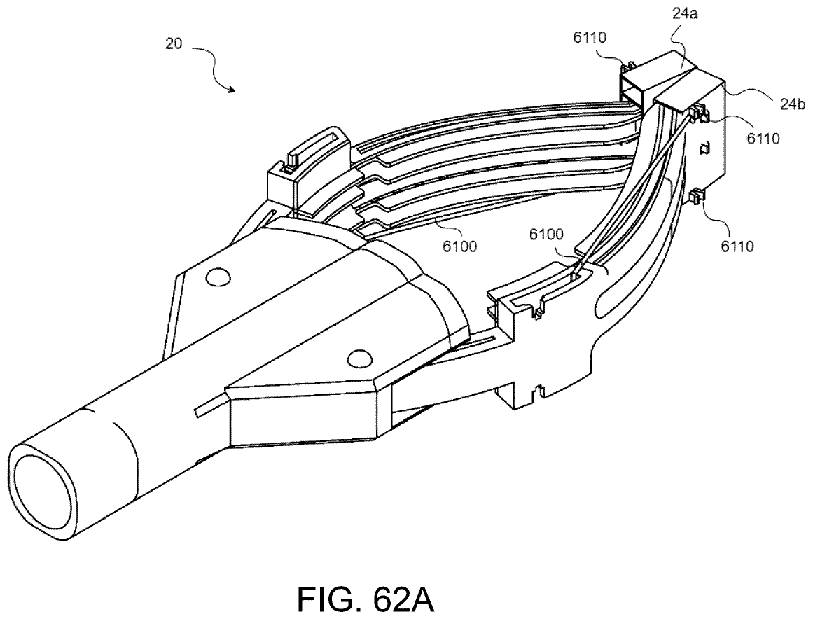

Referring to FIGS. 60A to 62B, there is shown further schematics of another example of a gripping tool 10 including alternate covers 24a, 24b which can be moved between an operable and stowed position. In this embodiment, each gripping cover 24a, 24b is coupled to the gripping tool 10 via a tether 6100 as shown in FIGS. 61A, 61B, 62A, and 62B. As shown in these figures, the tether 6100 for cover 24a extends across the underside of the respective gripping arm and the tether for cover 24b extends across the top surface of the respective gripping arm. Each tether 6100 can be attached to the respective cover in various ways such as via a knot, but other attachments are possible such as via an adhesive. For example, in FIGS. 60A to 62B, the tether 6100 for cover 24a is coupled via a knot and the tether 6100 for cover 24b is coupled via an adhesive. However, it will be appreciated that the same attachment method can be used for both covers 24a, 24b and that FIGS. 60A to 62B are merely exemplary of two different method that could be used. In a preferable form, each tether 6100 is an elastic tether, such as an elastic band. In this embodiment, the elastic nature of the tether 6100 is configured to elastically bias the respective gripping cover 24a, 24b into engagement with the respective gripping end. This is advantageous to maintain a positive engagement between each cover 24a, 24b and the gripping end in addition to the mechanical coupling between each cover 24a, 24b and the respective gripping end. As shown in FIG. 61, each elastic tether 6100 is coupled at a first end to a midpoint of the respective gripping arm adjacent to the region where the gripping cover 24a, 24b is stowed, and a second end of the elastic tether 6100 is coupled to the cover 24a, 24b. Each cover 24a, 24b is provided with a pair of snap-fit protrusions 6110 which cooperate with snap-fit apertures in the outer surface of each gripping arm to provide a snap-fit releasable coupling between each cover and the respective gripping arm. In one variation, each gripping cover 24a, 24b is coupled to the gripping tool 10 via a plurality of tethers 6100, such as a plurality of elastic tethers. In this arrangement, for each cover 24a, 24b, a first tether extends across the top surface of the respective gripping arm and a second tether extends across the bottom surface of the respective gripping arm. As shown in FIG. 60B, the inner surfaces 6002, 6004 of the interleaving fingers include non-slip material, such as silicon, rubber, or the like. As also shown in FIG. 60B, the upper edges 6006, 6008 of frame 90 surrounding the hinge mechanism of the interleaving fingers include non-slip material, such as silicon, rubber, or the like. It will be appreciated that different snap-fitting arrangements can be used. For example, male snap-fitting couplings can be provided on the covers which cooperate with female snap-fitting couplings located on the gripping arms, and in other arrangements female snap-fitting couplings can be provided on the covers which cooperate with male snap-fitting couplings located on the gripping arms.

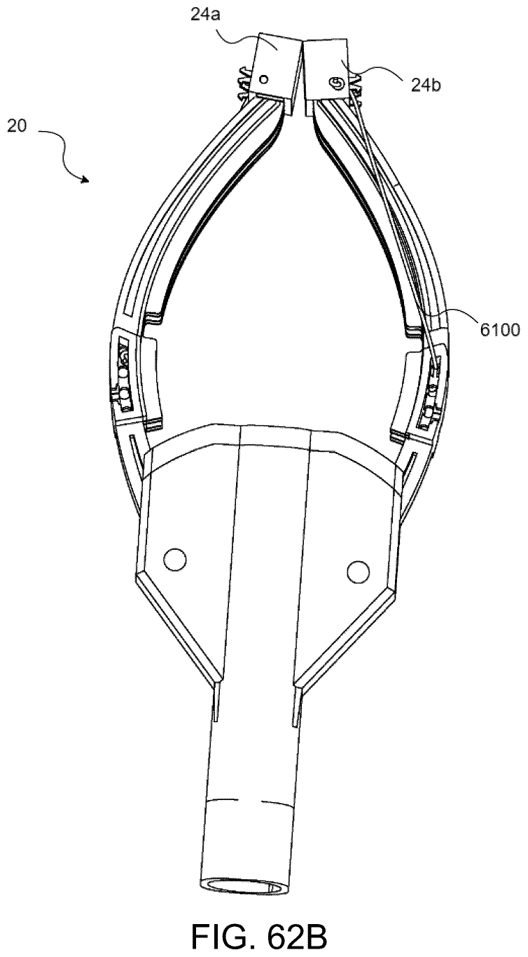

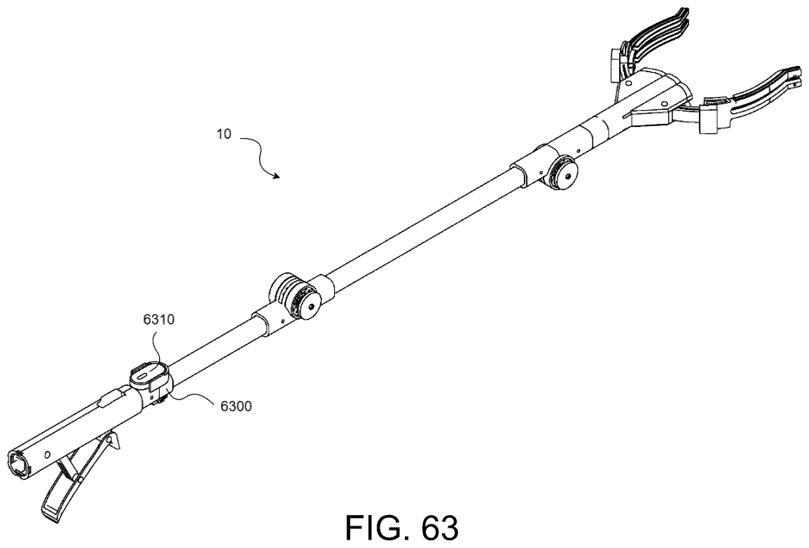

Referring to FIGS. 63 and 64, there is shown a schematic of another example of the gripping tool 10 having mounted thereto a wireless controller 6300. In particular, the gripping tool 10 includes a housing 6310 mounted relative to the elongate body 12. The housing 6310 is configured to house the wireless controller 6300 for controlling a further electronic device. In one example, the gripping ends of the gripping tool 10 may grip a smart phone, wherein the user may be able to interact with the controller 6300 to control the smart phone, such as take a phone or video whilst the smart phone is out of reach. In one form the controller 6300 may be provided in the form of a VeFly Shutter Release controller. However, it will be appreciated that other wireless controllers may be used. In one form, the housing 6310 may be provided in the form of a clasp type mounting, including a housing portion 6312 which encircles a portion of the elongate body 12 and is held in a clasped position via a bolt 6314 and nut 6316.

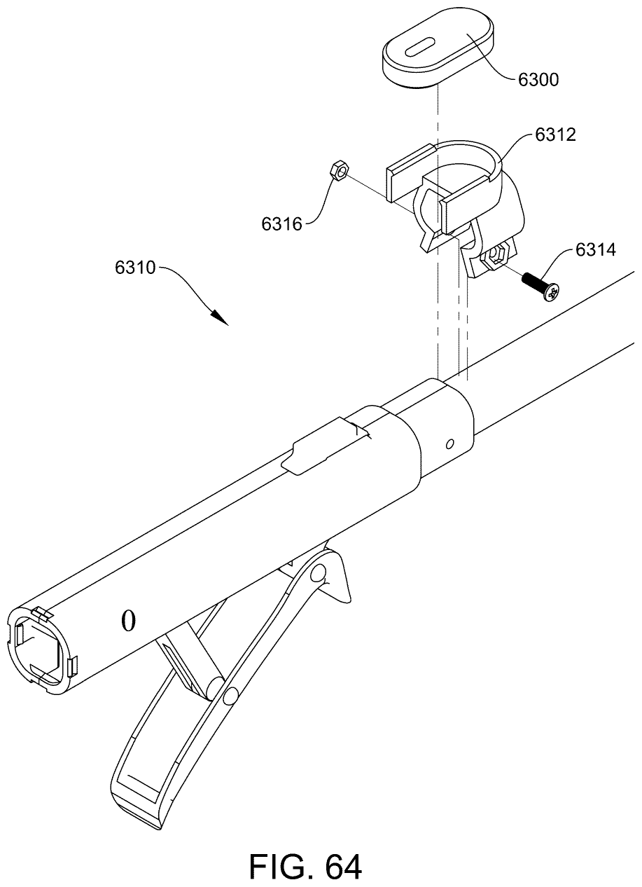

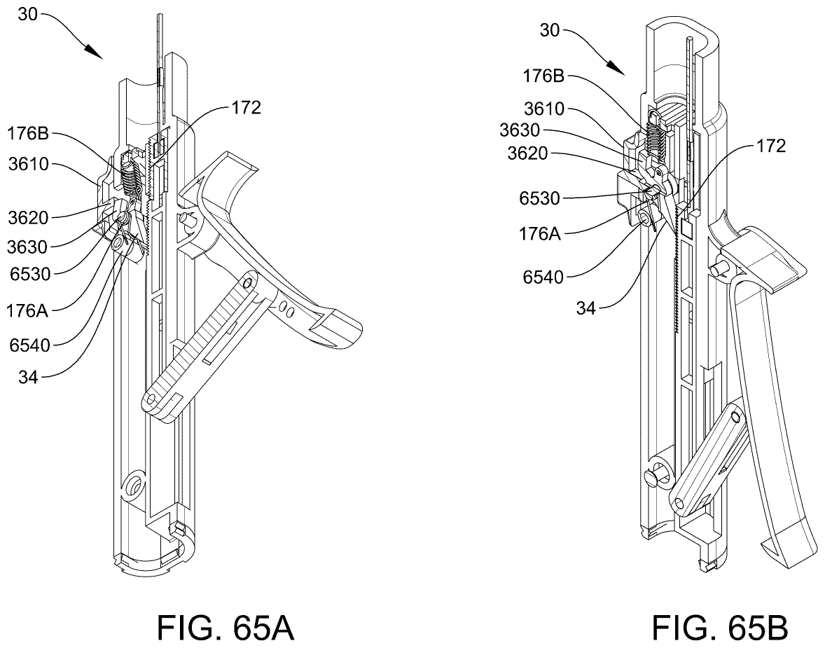

Referring to FIGS. 65A and 65B, there is shown various schematics of another alternate ratchet mechanism 168 for the gripping tool 10 of FIG. 1. FIG. 65A shows a magnified cross-sectional view of the handle of the gripping tool 10, where the ratchet mechanism 168 is in a disengaged position, and FIG. 65B show a magnified cross-sectional view of the ratchet mechanism 168 is in the engaged position.

The ratchet mechanism 168 of FIGS. 65A and 65B include a slidable button assembly including a slidable button 3610 to cooperate with and rotatably actuate the pawl 34 of the ratchet mechanism 168. The slidable button assembly provides ergonomic advantages to actuate the pawl 34. As will be appreciated from the embodiment of the gripping tool 10 described in relation to FIG. 1, the pawl 34 is configured to be rotated to engage and disengage with the ratchet 172. The slidable button 3610 of the slidable button assembly allows for a transfer of the slidable motion of the button 3610 to the pawl 34 to cause rotational actuation thereof, thereby actuating the pawl 34 to either an engaged pawl position or disengaged pawl position. In certain forms, the button 3610 can be slidably actuated in a direction parallel to the longitudinal body axis.

As shown in FIGS. 65A and 65B, the pawl 34 is coupled to two biasing devices, namely two springs 176A, 176B. The pawl 34 includes a hole which receives therethrough a first protrusion 6530 coupled to the slidable button 3610, wherein the first protrusion 6530 acts as a form of an axle for the pawl 34 to rotate thereabout. The first spring 176A, provided in the form of a torsion spring, is located on the axle 6530. A first tail of the first spring 176A presses against a protrusion 6540 extending from the inner surface of the handle wall. A midsection of the first spring 176A contacts and urges against a surface adjacent an engaging end of the pawl 34. The first spring 176A operates similarly to a clothesline spring. The first spring 176A is under rotational tension such that the first spring 176A applies a torque to rotate the pawl 34 in an anti-clockwise direction as shown in the FIG. 65A so as to engage the pawl 34 with a portion of the ratchet 172 so that the ratchet mechanism 168 is in the engaged position as shown in FIG. 65B.

The pawl of FIGS. 65A and 65B also includes a second spring 176B, provided in the form of a tension spring (e.g., extension spring), which has a first tail coupled, directly or indirectly, to the inner structure of the handle, and a second tail coupled to an actuatable finger of the pawl 34. The second spring 176B is under a tensile force and applies a torque to the pawl 34 also in an anticlockwise direction to rotate the pawl 34 into engagement with a portion of the ratchet 172. In this configuration, the first and second springs 176A, 176B simultaneously apply torque to the pawl 34 to bias the pawl 34 into engagement with the ratchet 172 and into the engaged position.

As shown in FIG. 65A, the pawl 34 of FIGS. 65A to 65D includes an actuating finger 3620. The finger 3620 of the pawl 34 cooperates with the slidable button 3610 to cause the ratchet mechanism 168 to move between the engaged and disengaged position. As shown in FIGS. 65A and 65B, when the slidable button is moved by the user away from the second end of the elongate body, an inner wall structure 3620 of the slidable button 3610 contacts the finger 3620 of the pawl 34 and rotates the pawl to disengage the pawl from the ratchet 172. As the slidable button 3610 slides in a direction toward the second end of the elongate body, the torque applied by the first and second springs 6510, 6520 cause the pawl 34 to rotate such that the end of the pawl 34 contacts and engages with a portion of the ratchet 172, thereby causing the ratchet mechanism 168 to locate in the engaged position.

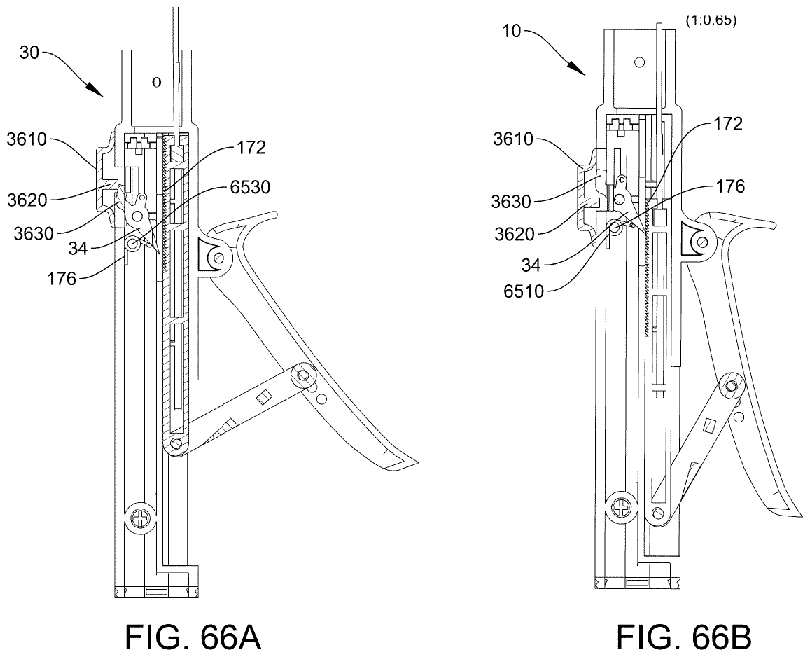

Referring to FIGS. 66A and 66B, there is shown various schematics of another alternate ratchet mechanism 168 for the gripping tool 10 of FIG. 1. The ratchet mechanism 168 of FIGS. 66A and 66B includes a slidable button assembly including a slidable button 3610 to cooperate with and rotatably actuate the pawl 34 of the ratchet and pawl mechanism 168. The slidable button assembly provides ergonomic advantages to actuate the pawl 34. As will be appreciated from the embodiment of the gripping tool 10 described in relation to FIG. 1, the pawl 34 is configured to rotate to engage and disengage with the ratchet 172.

In FIGS. 66A and 66B, the pawl 34 is coupled to a biasing device 176, namely a torsional spring. In particular, the pawl 34 includes a hole which receives therethrough a first protrusion 6530 coupled to the slidable button 3610, wherein the first protrusion 6530 acts as a form of an axle for the pawl 34 to rotate thereabout. The torsional spring 176 is located on the axle 6530. A first tail of the spring 176 contacts and urges against an inner surface of the handle wall. A second tail of the spring 176 presses against a surface adjacent an engaging end of the pawl 34. The spring 176 is under tension such that the spring 176 applies a torque to rotate the pawl 34 in an anti-clockwise direction as shown in the figures so as to engage the pawl 34 with a portion of the ratchet 172 so that the ratchet mechanism 168 is in the engaged position as shown in FIG. 66B.

Similar to FIGS. 65A and 65B, the pawl 34 of FIGS. 66A and 66B includes an actuating finger 3630. The finger 3630 of the pawl 34 cooperates with the slidable button 3610 to cause the ratchet mechanism 168 to move between the engaged and disengaged position. In particular, as shown in FIG. 66A, an inner wall structure of the slidable button 3610 contacts the finger 3630 of the pawl 34. As the slidable button 3610 slides in a direction toward the second end of the body 12, the torque applied by the first spring 176 causes the pawl 34 to rotate such that the end of the pawl 34 contacts and engages with a portion of the ratchet 172, thereby causing the ratchet mechanism 168 to be located in the engaged position as shown in FIG. 66B. The user can then slide the button in a direction toward the first end of the body, such that the inner wall structure of the slidable button 3610 applies a torque to the pawl 34 to cause the pawl 34 to rotate in a clockwise direction, thereby moving the ratchet mechanism 168 to the disengaged position.

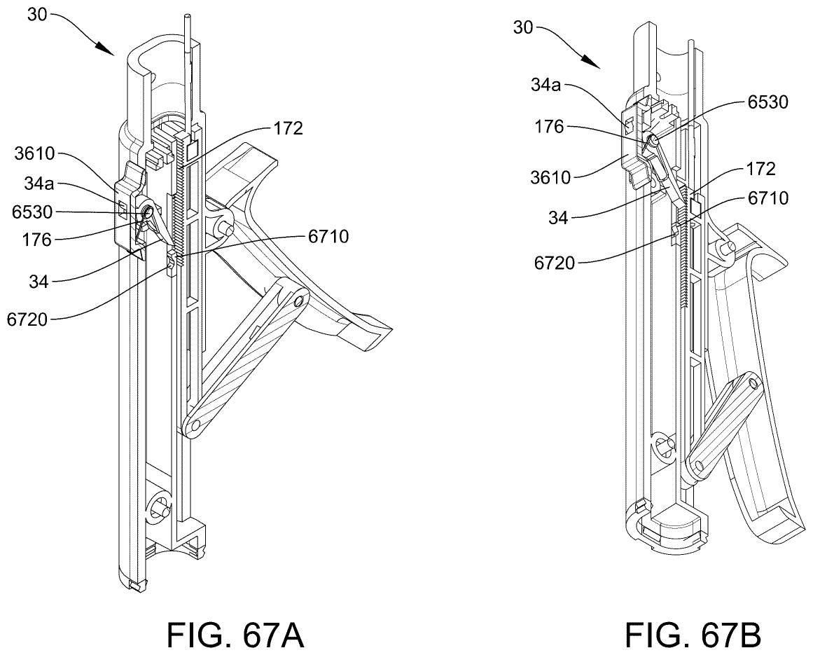

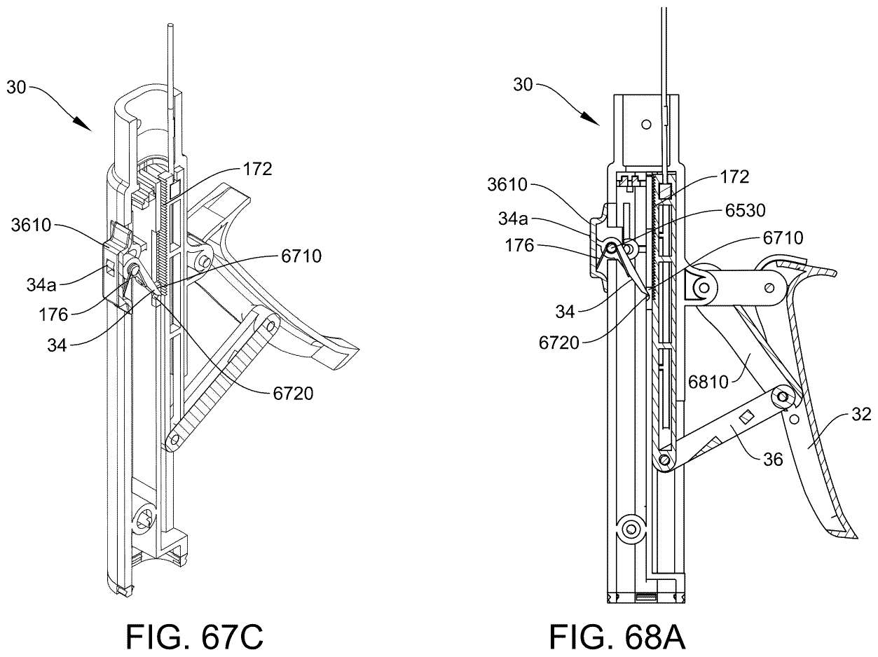

Referring to FIGS. 67A to 67C there is shown various schematics of another alternate ratchet mechanism 168 for the gripping tool 10 of FIG. 1. The ratchet mechanism of FIGS. 67A to 67C includes a slidable button assembly including a slidable button 3610 to cooperate with and rotatably actuate the pawl 34 of the ratchet and pawl mechanism 168. The slidable button assembly provides ergonomic advantages to actuate the pawl 34. As will be appreciated from the embodiment of the gripping tool 10 described in relation to FIG. 1, the pawl 34 is configured to be rotated to thereby engage and disengage with the ratchet 172. In this configuration of FIGS. 67A to 67F, a hand-actuable portion of the pawl 34a can extend outwardly from a hole 3611 in the upper surface of the slidable button 3610. The slidable button 3610 of the slidable button assembly allows for a transfer of the slidable motion of the button 3610 to the pawl 34 to cause rotational actuation thereof, thereby actuating the pawl 34 to either the engaged or disengaged position. In certain forms, the button 3610 can be slidably actuated in a direction parallel to the longitudinal body axis.

In FIGS. 67A to 67C, the pawl 34 is coupled to a biasing device 176, namely a torsional spring. In particular, the pawl 34 includes a hole which receives therethrough a first protrusion 6530 extending from the inner surface of the handle wall or button 3610, wherein the first protrusion 6530 acts as a form of an axle for the pawl 34 to rotate thereabout. The torsional spring 176 is located on the axle 6530. A first tail of the spring 176 presses against an inner surface of the slidable button 3610. A second tail of the spring 176 presses against a surface adjacent an engaging end of the pawl 34. The spring 176 is under tension such that the spring 176 applies a torque to rotate the pawl 34 in an anti-clockwise direction as shown in the figures so as to engage the pawl 34 with a portion of the ratchet 172 so that the ratchet mechanism 168 is in the engaged position as shown in FIG. 67B.

The pawl 34 of FIGS. 67A to 67C includes an actuating finger. The finger of the pawl 34 cooperates with the slidable button 3610 to cause the ratchet mechanism 168 to move between the engaged and disengaged position. In particular, as shown in FIG. 67A, an inner wall structure of the slidable button 3610 contacts the finger 34A of the pawl 34. As the slidable button 3610 slides in a direction toward the second end of the body, the torque applied by the spring 6520 causes the pawl 34 to rotate such that the end of the pawl 34 contacts and engages with a portion of the ratchet 172, thereby causing the ratchet mechanism 168 to be located in the engaged position.

As clearly shown in FIG. 67C, the handle can include a disengagement structure 6710 which is provided in an exemplary form having a “V” shaped cross-section. In this configuration, the user can disengage the pawl from the ratchet via actuation of the pawl via the hole in the button and then sliding the slidable button 3610 toward the second end of the body to align the pawl 34 with the disengagement structure 6710. The user can then release contact with the pawl such that the tail of the pawl 34 is biased into contact with the disengagement structure elevated above the teeth of the ratchet 172. The pawl tail is supported within a groove 6720 of the disengagement structure 6710. In this position, the gripping mechanism is free to move from the closed position to the open position due to the pawl being maintained in a disengaged position whilst in contact with the disengagement structure. If the user slidably moves the button toward the first end of the body, the pawl will move out of contact with the disengagement structure and re-engage with the ratchet such that the ratchet is located in the engaged position again. It is also possible for the user to actuate the pawl via the hole in the button to lift the pawl out of engagement with the disengagement structure 6720 whilst simultaneously sliding the button toward the first end of the body and then releasing contact with the pawl such that the pawl re-engages with the ratchet in the engaged position.

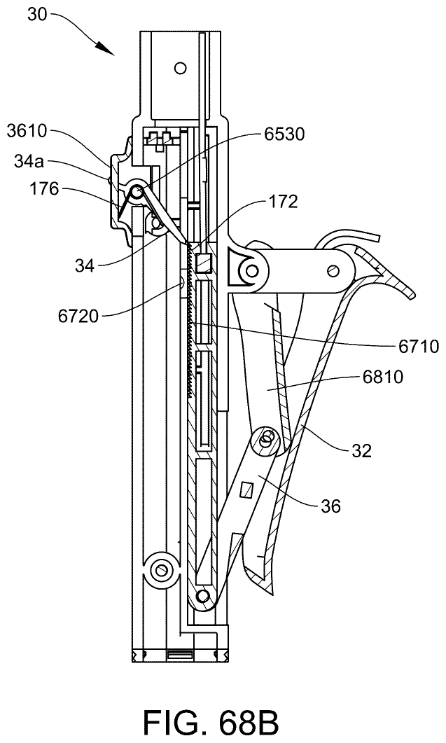

Referring to FIGS. 68A and 68B, there is shown an alternate trigger mechanism for the gripping tool of FIG. 1. In this arrangement, the alternate trigger arrangement includes a plurality of intermediate linkage members 36, 6810. In particular, the trigger 32a is operably coupled to the slidably ratchet 172 via a pair of linkage members 36, 6810. In particular, a mounting member extends outwardly from the handle. The trigger 32 is pivotally secured to the outward end of the mounting member. A first linkage member 6810 is pivotably mounted between a mounting portion of the handle and a mid-portion of the trigger 32. A second linkage member 36 is pivotally mounted between the mid-portion of the trigger 32 and the end of the ratchet 172. As the trigger 32 is pressed by the user, the second linkage member 36 slidably moves the ratchet toward the end of the handle as shown in FIG. 68B. As the trigger 36 is released and the ratchet mechanism is in the unlocked position, the ratchet member 172 slidably moves away from the end of the handle causing the trigger 32 to rotate outwardly from the handle as shown in FIG. 68A. It will be appreciated that a plurality of linkage members can be utilised for the trigger mechanism.

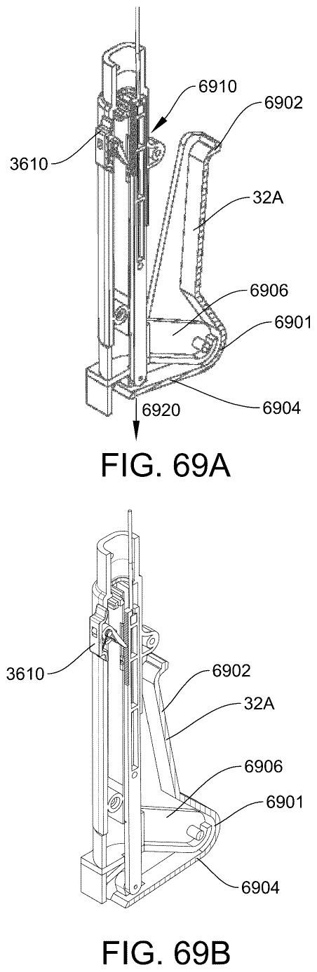

Referring to FIGS. 69A and 69B, there is shown a further alternate trigger mechanism for the gripping tool of FIG. 1. As shown in these figures, a midsection 6901 of the trigger 32a is pivotally coupled to a mounting member 6906 of the handle. Referring to FIG. 69A, a hand actuatable end 6902 of the trigger 32a can be squeezed by the user toward the longitudinal axis of the elongate body as represented by arrow 6910. An opposing free end 6920 of the trigger 32a is operably and pivotally coupled to the ratchet 172. When the hand actuatable end of the trigger 32a is squeezed, the opposing free end 6904 coupled to the ratchet 172 moves the ratchet 172 along the elongate body defining the handle. In FIG. 69A, the pawl 34 is disengaged from the ratchet 172 and then in FIG. 69B the pawl member 34 is engaged with the ratchet 172. If the user disengages the pawl 34 from the ratchet 172 in the position shown in FIG. 69A, as discussed in various embodiments within this specification, the biasing device 80 applies a force to the force transfer medium resulting in the ratchet moving in an opposite direction within the handle defined by the elongate body, resulting in the trigger 32a pivoting outwardly as shown in FIG. 69A. In this embodiment, the ratchet mechanism 168 is configured according to the embodiment shown in FIGS. 67A and 67B. However, it will be appreciated that other ratchet and pawl mechanisms 168 described and illustrated in the specification can be used in combination with the alternate trigger mechanism of FIGS. 69A and 69B.

As will be appreciated from the embodiments disclosed in FIG. 1 and FIG. 71, the gripping tool 10 of FIG. 1 can be provided without a hinge assembly 40 to provide a gripping assembly as depicted in FIG. 71. It will be appreciated that that all other features disclosed in relation to the embodiment of FIG. 1, or disclosed with reference to modification of the embodiment to FIG. 1, equally apply to the embodiment disclosed in FIG. 71.

It will be appreciated throughout the above description that the gripping tool 10 has many different closed (e.g., gripped) positions depending upon the object that needs to be gripped. Movement of the gripping arms 22a, 22b from the open position should be understood to represent one of many positions which could be considered a closed position of the gripping mechanism 20.

In this specification, adjectives such as first and second, left and right, top and bottom, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step etc.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the spirit and scope of the above-described invention.

In this specification, the terms ‘comprises’, ‘comprising’, ‘includes’, ‘including’, or similar terms are intended to mean a non-exclusive inclusion, such that a method, system, or apparatus that comprises a list of elements does not include those elements solely but may well include other elements not listed.

It should be appreciated that the term connected, when used in the claims, should not be interpreted as being limited to direct connections only. The terms “coupled” and “connected,” along with their derivatives, may be used. It should be understood that these terms are not intended as synonyms for each other. Thus, the scope of the expression a device A connected to a device B should not be limited to devices or systems wherein an output of device A is directly connected to an input of device B. It means that there exists a path between an output of A and an input of B which may be a path including other devices or means. “Connected” may mean that two or more elements are either in direct physical contact, or that two or more elements are not in direct contact with each other but yet still co-operate or interact with each other, unless otherwise specified.

The reference in this specification to any known matter or any prior publication is not, and should not be taken to be, an acknowledgment or admission or suggestion that the known matter or prior art publication forms part of the common general knowledge in the field to which this specification relates.

While specific examples of the invention have been described, it will be understood that the invention extends to alternative combinations of the features disclosed or evident from the disclosure provided herein.

Many and various modifications will be apparent to those skilled in the art without departing from the scope of the invention disclosed or evident from the disclosure provided herein.

1. A gripping tool including:
an elongate body having a first end, a second end, a longitudinal body axis, and a handle located at the second end of the elongate body, wherein the handle has a longitudinal handle axis which is substantially coaxial with at least a portion of the longitudinal body axis;
a gripping mechanism located at the first end of the elongate body;
a ratchet mechanism configured to restrict the gripping mechanism moving from a closed position to an open position, wherein the ratchet mechanism includes a pawl member configured to cooperate with a ratchet member, wherein the ratchet member is movable relative to the elongate body along the longitudinal body axis;
a trigger mechanism operably coupled to the gripping mechanism, including:
a trigger pivotally coupled to the elongate body and operably coupled to the ratchet member; and
a force transfer medium operably coupled between the ratchet member and the gripping mechanism;
wherein actuation of the trigger causes the ratchet member to move causing the force transfer medium to actuate the gripping mechanism to move from an open position to a closed position.

2. The gripping tool of claim 1, wherein the ratchet mechanism includes a pawl biasing device configured to bias the pawl member into cooperation with the ratchet member.

3. The gripping tool of claim 1 or 2, wherein the ratchet member is linearly movable relative to the elongate body.

4. The gripping tool of any one of claims 2 to 3, further including a button operably coupled to the pawl member, wherein button is movable between an engaged position, wherein the pawl member is engaged with the ratchet member such that the gripping mechanism is restricted from moving from the closed position to the open position, and a disengaged position, wherein the pawl member is disengaged from the ratchet member such that the gripping mechanism is free to move from the closed position to the open position.

5. The gripping tool of claim 4, wherein the button is slidably actuatable in a direction parallel to the longitudinal body axis.

6. The gripping tool of claim 4 or 5, wherein the pawl member is rotatably coupled to the button via an axle.

7. The gripping tool of any one of claims 4 to 6, wherein the handle includes a disengagement structure, wherein slidable movement of the button from the engaged position to the disengaged position causes the pawl member to disengage from the ratchet member and be supported upon the disengagement structure.

8. The gripping tool of claim 7, wherein slidable movement of the button from the disengaged position to the engaged position causes the pawl member to separate from the disengagement structure and cooperate with the ratchet member.

9. The gripping tool of any one of claims 4 to 6, wherein the handle includes a hole to allow user actuation of the pawl member via the hole to disengage the pawl member from the ratchet member, wherein the handle includes a disengagement structure, wherein user actuation of the pawl member via the hole in the button and slidable movement of the button from the engaged position to the disengaged position causes the pawl member to disengage from the ratchet member and be supported upon the disengagement structure.

10. The gripping tool of claim 9, wherein user actuation of the pawl member via the hole in the button and slidable movement of the button from the disengaged position to the engaged position causes the pawl member to separate from the disengagement structure and cooperate with the ratchet member.

11. The gripping tool of any one of claims 4 to 10, further including a frame insert to snap-fittingly engage with a hole in a wall of the handle, wherein the button is removably attachable to the frame insert for cooperation with the pawl member.

12. The gripping tool of claim 2 or 3, wherein the handle includes a disengagement structure, wherein the pawl member is configured to slidably move in a first direction along an axle and orthogonal relative to the longitudinal handle axis to a disengaged position to disengage the pawl member from the ratchet member and be supported by the disengagement structure.

13. The gripping tool of claim 12, wherein the pawl member is configured to slidably move in a second direction, opposite to the first direction and along the axle, to an engaged position, wherein the pawl member is configured to separate from the disengagement structure and engage with the ratchet member.

14. The gripping tool of any one of claims 7 to 13, wherein the disengagement structure is configured to support the pawl member under bias from the pawl biasing device.

15. The gripping tool of any one of claims 2 to 14, wherein the pawl biasing device includes one or more springs.

16. The gripping tool of any one of claims 1 to 15, wherein the force transfer medium is coupled to a biasing device to bias the gripping mechanism from the closed position to the open position.

17. The gripping tool of any one of claims 1 to 16, wherein the gripping mechanism includes a pair of levers which are operably connected to a slidable member, wherein slidable movement of the slidable member in response to actuation of the trigger actuates the pair of levers thereby moving the gripping mechanism toward the closed position.

18. The gripping tool of any one of claims 1 to 17, wherein the gripping mechanism includes a first plurality of fingers pivotally connected to a second plurality of fingers, wherein the first and second plurality of fingers interleave when moved toward the closed position.

19. The gripping tool of any one of claims 1 to 18, wherein the gripping mechanism includes a plurality of gripping covers releasably attached to the gripping ends.

20. The gripping tool of claim 19, wherein the plurality of gripping covers are releasably attachable to the gripping tool in a stowed position remote to the gripping ends, wherein the covers are releasably detachable from the stowed position and releasably attachable to the gripping ends in an operable position.

21. The gripping tool of claim 20, wherein each gripping cover is further coupled to the gripping tool via one or more tethers.

22. The gripping tool of claim 21, wherein the tethers are elastic tethers.

23. The gripping tool of any one of claims 1 to 22, wherein the elongate body includes a plurality of body portions pivotally connected together via one or more hinge assemblies, wherein each hinge assembly has one or more locked positions to maintain an angular displacement between connected body portions, and one or more unlocked positions.

24. The gripping tool of claim 23, wherein the gripping tool is movable between a stowed position, wherein the plurality of body portions are foldable upon each other via the plurality of hinge assemblies, and a deployed position, wherein the plurality of body portions are aligned along a longitudinal axis of the elongate body.

25. The gripping tool of any one of claims 1 to 24, wherein substantial coaxiality between the longitudinal axis and the longitudinal body axis includes an angle of deflection between one of:
0 to 20 degrees;
0 to 15 degrees;
0 to 10 degrees; and
0 to 5 degrees.

26. The gripping tool of any one of claims 1 to 25, wherein one or more linkage members are operably coupled between the trigger and the ratchet member.

27. The gripping tool of any one of claims 1 to 26, wherein the handle includes a releasable coupling mechanism for releasably coupling the gripping tool to an object.

28. A gripping tool including:
an elongate body having a first end, a second end, wherein a handle is located at the second end of the elongate body;
a gripping mechanism located at the first end of the elongate body, the gripping mechanism including gripping ends;
a trigger mechanism operably coupled to the gripping mechanism to cause the gripping mechanism to move between an open position and a closed position in response to actuation of a trigger of the trigger mechanism; and
a plurality of gripping covers movable between an operable position, wherein each gripping cover is releasably attachable to one of the gripping ends of the gripping mechanism, and a stowed position, wherein each gripping cover is releasably attached to the gripping tool whilst being stowed remote to the gripping ends, wherein each gripping cover is coupled to the gripping tool via one or more tethers.

29. The gripping tool of claim 28, wherein each tether is an elastic tether.

30. The gripping tool of claim 29 or 30, wherein in the stowed position, the plurality of covers are snap-fittingly attached.

31. The gripping tool of claim 30, wherein each cover includes one or more male snap fitting joints which snap-fittingly attach to a respective one or more female snap fitting joints located on a portion of the gripping mechanism.

32. The gripping tool of claim 31, wherein each cover includes one or more female snap fitting joints which snap-fittingly attach to a respective one or more male snap fitting joints located on a portion of the gripping mechanism.

33. The gripping tool of any one of claims 28 to 32, wherein the elongate body has a longitudinal body axis, and the handle has a longitudinal handle axis which is substantially coaxial with at least a portion of the longitudinal body axis.

34. The gripping tool of any one of claims 28 to 33, wherein the gripping tool further includes a force transfer medium operably coupled between the trigger mechanism and the gripping mechanism, wherein actuation of the trigger causes the force transfer medium to actuate the gripping mechanism to move from the open position to the closed position.

35. The gripping tool of claim 34, wherein the gripping tool further includes a ratchet mechanism configured to restrict the gripping mechanism moving from the closed position to the open position, wherein the ratchet mechanism includes a pawl member configured to cooperate with a ratchet member, wherein the ratchet member is movable relative to the elongate body along the longitudinal body axis, wherein the ratchet member is operably coupled to the trigger and the force transfer medium.

36. The gripping tool of claim 35, wherein one or more linkage members are operably coupled between the trigger and the ratchet member.

37. The gripping tool of claim 35 or 36, wherein the ratchet mechanism includes a pawl biasing device configured to bias the pawl member into cooperation with the ratchet member.

38. The gripping tool of any one of claims 37, further including a button operably coupled to the pawl member, wherein button is movable between an engaged position, wherein the pawl member is engaged with the ratchet member such that the gripping mechanism is restricted from moving from the closed position to the open position, and a disengaged position, wherein the pawl member is disengaged from the ratchet member such that the gripping mechanism is free to move from the closed position to the open position.

39. The gripping tool of claim 38, wherein the button is slidably actuatable in a direction parallel to the longitudinal body axis.

40. The gripping tool of claim 38 or 39, wherein the pawl member is rotatably coupled to the button via an axle.

41. The gripping tool of any one of claims 38 to 40, wherein the handle includes a disengagement structure, wherein slidable movement of the button from the engaged position to the disengaged position causes the pawl member to disengage from the ratchet member and be supported upon the disengagement structure.

42. The gripping tool of claim 41, wherein slidable movement of the button from the disengaged position to the engaged position causes the pawl member to separate from the disengagement structure and cooperate with the ratchet member.

43. The gripping tool of any one of claims 38 to 40, wherein the handle includes a hole to allow user actuation of the pawl member via the hole to disengage the pawl member from the ratchet member, wherein the handle includes a disengagement structure, wherein user actuation of the pawl member via the hole in the button and slidable movement of the button from the engaged position to the disengaged position causes the pawl member to disengage from the ratchet member and be supported upon the disengagement structure.

44. The gripping tool of claim 43, wherein user actuation of the pawl member via the hole in the button and slidable movement of the button from the disengaged position to the engaged position causes the pawl member to separate from the disengagement structure and cooperate with the ratchet member.

45. The gripping tool of any one of claims 38 to 44, further including a frame insert to snap-fittingly engage with a hole in a wall of the handle, wherein the button is removably attachable to the frame insert for cooperation with the pawl member.

46. The gripping tool of claim 37, wherein the handle includes a disengagement structure, wherein the pawl member is configured to slidably move in a first direction along an axle and orthogonal relative to the longitudinal handle axis to a disengaged position to disengage the pawl member from the ratchet member and be supported by the disengagement structure.

47. The gripping tool of claim 46, wherein the pawl member is configured to slidably move in a second direction, opposite to the first direction and along the axle, to an engaged position, wherein the pawl member is configured to separate from the disengagement structure and engage with the ratchet member.

48. The gripping tool of any one of claims 41 to 47, wherein the disengagement structure is configured to support the pawl member under bias from the pawl biasing device.

49. The gripping tool of any one of claims 37 to 48, wherein the pawl biasing device includes one or more springs.

50. The gripping tool of any one of claims 34 to 49, wherein the force transfer medium is coupled to a biasing device to bias the gripping mechanism from the closed position to the open position.

51. The gripping tool of any one of claims 28 to 50, wherein the gripping mechanism includes a pair of levers which are operably connected to a slidable member, wherein slidable movement of the slidable member actuates the pair of levers thereby moving the gripping mechanism toward the closed position.

52. The gripping tool of any one of claims 28 to 51, wherein the gripping mechanism includes a first plurality of fingers pivotally connected to a second plurality of fingers, wherein the first and second plurality of fingers interleave when moved toward the closed position and the covers being in the stowed position.

53. The gripping tool of any one of claims 28 to 52, wherein the gripping mechanism includes a first gripping arm pivotally connected to a second gripping arm, wherein gripping surfaces of the first and second gripping arms include an anti-slip material.

54. The gripping tool of any one of claims 28 to 53, wherein the gripping mechanism includes a first gripping arm pivotally connected to a second gripping arm, wherein a pivotal connection between the first and second gripping arms are at least partially housed by a frame, wherein a portion of the frame includes an anti-slip material.

55. The gripping tool of any one of claims 28 to 54, wherein the elongate body includes a plurality of body portions pivotally connected together via one or more hinge assemblies, wherein each hinge assembly has one or more locked positions to maintain an angular displacement between connected body portions, and one or more unlocked positions.

56. The gripping tool of claim 55, wherein the gripping tool is movable between a stowed position, wherein the plurality of body portions are foldable upon each other via the plurality of hinge assemblies, and a deployed position, wherein the plurality of body portions are aligned along a longitudinal axis of the elongate body.

57. The gripping tool of any one of claims 28 to 56, wherein the gripping tool includes a wireless controller to control an electronic device gripped by the gripping tool 58. The gripping tool of any one of claims 27 to 57, wherein the handle includes a releasable coupling mechanism for releasably coupling the gripping tool to an object.
